(19) United States
(12) Patent Application Publication
(10) Pub. No.: US 2024/0297699 A1
(43) Pub. Date: Sep. 5, 2024

(54) METHOD FOR SWITCHING ANTENNA SWITCHING CONFIGURATION AND DEVICE

(71) Applicant: Beijing Xiaomi Mobile Software Co., Ltd., Beijing (CN)

(72) Inventor: Yang LIU, Beijing (CN)

(73) Assignee: Beijing Xiaomi Mobile Software Co., Ltd., Beijing (CN)

(21) Appl. No.: 18/270,777

(22) PCT Filed: Jan. 5, 2021
(86) PCT No.: PCT/CN2021/070336

§ 371 Date: Jul. 3, 2023

(51) Int. Cl. H04B 7/06; H04W 8/22

(52) U.S. Cl. CPC H04B 7/0626; H04B 7/063; H04B 7/0632; H04W 8/22

(57) ABSTRACT

In a method for switching an antenna switching configuration, the switching of antenna switching configuration is performed according to a CSI measurement report including antenna switching configuration information reported by a terminal side.

### CROSS-REFERENCE

The present application is a U.S. National Stage of International Application No. PCT/CN2021/070336, filed on Jan. 5, 2021, the contents of all of which are incorporated herein by reference in their entireties for all purposes.

### BACKGROUND

In the field of communications, terminals may need to change antenna configurations in order to adapt to changes in services or scenarios. A current antenna configuration can be realized through radio resource control (RRC) reconfiguration or Bandwidth Part (BWP) switching. However, this switching is mainly realized by rescheduling on a network side through service changes and cannot be triggered according to conditions on a terminal side.

### SUMMARY

An embodiment according to a first aspect of the present disclosure provides a method for switching an antenna switching configuration. The method is performed by a terminal, and includes: receiving a channel state information (CSI) measurement report request related to switching of the antenna switching configuration, where the CSI measurement report request is configured to indicate a measurement resource of CSI measurement configuration; performing CSI measurement to obtain a CSI measurement report, where the CSI measurement report includes configuration information of antenna switching; and reporting the CSI measurement report to a network device.

An embodiment according to a second aspect of the present disclosure provides a method for switching an antenna switching configuration. The method is performed by a network device includes: sending to a terminal a CSI measurement report request related to the switching of the antenna switching configuration, where the CSI measurement report request is configure to indicate a measurement resource of CSI measurement configuration; receiving a CSI measurement report sent by the terminal, where the CSI measurement report includes configuration information of antenna switching; and changing the antenna switching configuration of the terminal based on the CSI measurement report.

An embodiment according to a third aspect of the present disclosure provides a communication device, including: a transceiver; a memory; and a processor connected to the transceiver and the memory respectively, which is configured to control radio signal transceiving of the transceiver by executing computer-executable instructions on the memory, and performs the method for switching an antenna switching configuration provided in the embodiments according to the first aspect or the second aspect.

An embodiment according to a fourth aspect of the present disclosure provides a non-transitory readable computer storage medium storing computer-executable instructions, where the computer-executable instructions when being executed by a processor, performs the method for switching an antenna switching configuration provided in the embodiments according to the first aspect or the second aspect.

Additional aspects and advantages of the present disclosure will be set forth partially in the following description, which will become obvious in the following description, or can be learned by practice of the present disclosure.

### BRIEF DESCRIPTION OF THE DRAWINGS

The above and/or additional aspects and advantages of the disclosure will become obvious and comprehensible from the description of examples in conjunction with the drawings.

FIG. 1 is a flowchart of a method for switching an antenna switching configuration according to an embodiment of the present disclosure.

FIG. 2 is a flowchart of a method for switching an antenna switching configuration according to an embodiment of the present disclosure.

FIG. 3 is a flowchart of a method for switching an antenna switching configuration according to an embodiment of the present disclosure.

FIG. 4 is a flowchart of a method for switching an antenna switching configuration according to an embodiment of the present disclosure.

FIG. 5 is a flowchart of another method for switching an antenna switching configuration according to an embodiment of the present disclosure.

FIG. 6 is a flowchart of another method for switching an antenna switching configuration according to an embodiment of the present disclosure.

FIG. 7 is a schematic structural diagram of an apparatus for switching an antenna switching configuration according to an embodiment of the present disclosure.

FIG. 8 is a schematic structural diagram of an apparatus for switching an antenna switching configuration according to an embodiment of the present disclosure.

FIG. 9 is a schematic structural diagram of a communication device according to an embodiment of the present disclosure.

### DETAILED DESCRIPTION

The embodiments of the present disclosure are described in detail below. Examples of the embodiments are shown in the accompanying drawings, in which the same or similar reference numerals represent the same or similar elements with the same or similar functions. The examples described with reference to the accompanying drawings are illustrative and intended to explain the present disclosure, rather than be construed as limiting the present disclosure.

The present disclosure relates to the technical field of mobile communications, and in particular to a method and an apparatus for switching an antenna switching configuration.

The technology described herein is not limited to the fifth-generation mobile communication (5th-generation, 5G) system and the subsequent evolution communication system, and is not limited to LTE/LTE-Advanced (LTE-A) system, and can also be used in various wireless communication systems, such as code division a plurality of access (CDMA), time division a plurality of access (TDMA), frequency division a plurality of access (FDMA), orthogonal frequency division a plurality of access (OFDMA), single-carrier frequency-division a plurality of access (SC-FDMA), and other systems.

The terminal provided by the embodiments of the present disclosure may be a mobile phone, a tablet computer, a notebook computer, an ultra-mobile personal computer (UMPC), a netbook or a personal digital assistant (PDA), a mobile Internet device (MID), a wearable device or a vehicle equipment, and the like.

Nowadays, the current antenna configuration can be realized through radio resource control (RRC) reconfiguration or Bandwidth Part (BWP) switching. However, this switching is mainly realized by rescheduling on a network side through service changes and cannot be triggered according to conditions on a terminal side. Therefore, the current antenna configuration cannot adapt to terminal and service requirements faster and more flexibly to support switching of antenna configuration. In addition, considering requirements for a further increase in the number of antennas of the terminal, the number of antennas can be increased so that the terminal can support a maximum of 6 antennas or 8 antennas. For a terminal that supports a greater number of antennas, the terminal can support more different antenna configurations. Therefore, it is more difficult for the current antenna configuration method to meet switching requirements of antenna switching configurations for such terminals.

The present disclosure provides a method and an apparatus for switching an antenna switching configuration, which can adapt to terminal and service requirements faster and more flexibly and support changes and rollbacks of the antenna switching configuration.

In view of this, the present disclosure provides a method and an apparatus for switching an antenna switching configuration, where the antenna switching configuration is switched according to the CSI measurement report reported by the terminal side and including at least one CQI. Therefore, the method for switching an antenna switching configuration according to the present application takes into consideration the antenna configuration supported by the terminal side, so as to adapt to the terminal and service requirements faster and more flexibly and support the switching of antenna switching configuration.

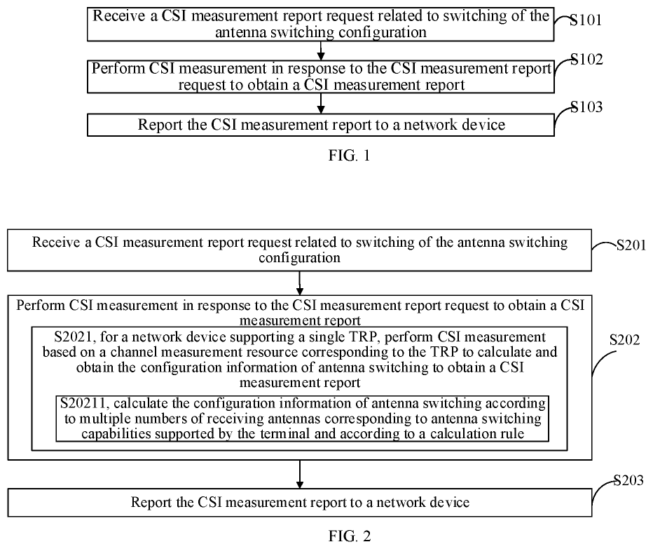

FIG. 1 shows a schematic flowchart of a method for switching an antenna switching configuration according to an embodiment of the present disclosure. In this embodiment, the method is performed by a terminal. As shown in FIG. 1, the method includes the following steps S101-S103.

In S101, receiving a CSI measurement report request related to switching of the antenna switching configuration, where the CSI measurement report request is configured to indicate a measurement resource of CSI measurement configuration.

In this embodiment, the terminal may receive a CSI measurement report request, and the CSI measurement report request is related to the switching of the antenna switching configuration. In other words, the CSI measurement report request is sent to realize switching of antenna switching configuration. For example, when it is required to switch antenna switching configuration, a network device may send a CSI measurement report request for the switching requirement of the antenna switching configuration, so as to obtain relevant information from the terminal for switching the antenna switching configuration.

The CSI measurement report request indicates a measurement resource configured for the CSI measurement and at least including channel measurement resources. In some embodiments, the CSI measurement report request may further include an interference measurement resource.

In S102, performing CSI measurement to obtain a CSI measurement report, where the CSI measurement report includes configuration information of antenna switching.

In this embodiment, after receiving the CSI measurement report request, the terminal may perform CSI measurement in response to the CSI measurement report request to obtain a CSI measurement report including configuration information of antenna switching.

In some embodiments, the configuration information of antenna switching includes at least one CQI or the configuration information of antenna switching includes at least one set of CQI and RI, that is, both CQ and RI are included. For example, one CQI and one RI may constitute a set of CQI and RI (also denoted as CQI/RI).

The CSI measurement report obtained by the terminal includes at least one CQI, or at least one set of CQI/RI. The terminal sends the CSI measurement report to the network device, and the network device may switch the antenna switching configuration according to at least one CQI or at least one set of CQI/RI included in the CSI measurement report.

In S103, reporting the CSI measurement report to the network device.

The network device may be a base station, and the base station may include a plurality of cells providing services for a terminal device. Depending on different specific applications, the base station may also be called an access point, or may be a device in an access network that communicates with a wireless terminal device through one or a plurality of sectors on an air interface, or may be called other names.

In this embodiment, the terminal reports the obtained CSI measurement report to the network device, and the network device switches the antenna switching configuration after obtaining the CSI measurement report. Specifically, the network device may change the antenna switching configuration of the terminal based on the configuration information of antenna switching included in the CSI measurement report.

In the embodiment of the present disclosure, after receiving the CSI measurement report request, the terminal reports the CSI measurement report including the configuration information of antenna switching to the network device, so that the network device can switch the antenna switching configuration based on the CSI measurement report. Therefore, in the method for switching an antenna switching configuration according to the embodiment of the present disclosure, the antenna configuration supported by the terminal side is taken into consideration, so as to adapt to the terminal and service requirements faster and more flexibly to support the switching of the antenna switching configuration.

In some embodiments, the CSI measurement report further includes at least one of: an expected number of receiving antennas; an expected number of transmitting antennas; or an antenna switching configuration expected to switch to. The expected number of receiving antennas indicates the number of receiving antennas that the terminal expects to use, the expected number of transmitting antennas indicates the number of transmitting antennas that the terminal expects to use, and the antenna switching configuration expected to switch to indicates the antenna switching configuration that the terminal expects to use. The expected number of receiving antennas, the expected number of transmitting antennas or the antenna switching configuration expected to switch to is usually the number of receiving antennas, the number of transmitting antennas or the antenna switching configuration that results in better communication quality.

In this embodiment, the terminal can obtain the expected number m′ of receiving antennas according to the calculated CQI, and can obtain the expected number n′ of transmitting antennas according to RI calculation and/or transmission requirements, and can further determine the antenna switching configuration n′Tm′R expected to switch to, (that is, n′ transmitting antennas and m′ receiving antennas). The terminal may include in the CSI measurement report at least one of the expected number m′ of receiving antennas, the expected number n′ of transmitting antennas, or the antenna switching configuration n′Tm′R expected to switch to and report the above to the network device. So that the network device can switch the antenna switching configuration according to at least one of the expected number m′ of receiving antennas, the expected number n′ of transmitting antennas, or the antenna switching configuration n′Tm′R expected to switch to, included in the CSI measurement report, and the CQI.

In the embodiment of the present disclosure, at least one of the expected number m′ of receiving antennas, the expected number n′ of transmitting antennas, and the antenna switching configuration n′Tm′R expected to switch to and the configuration information of antenna switching are simultaneously reported to the network device, so that the network device can fully consider the expected number of receiving antennas, the expected number of transmitting antennas and the antenna switching configuration expected to switch to on the terminal side when switching the antenna switching configuration.

FIG. 2 shows a schematic flowchart of a method for switching an antenna switching configuration according to an embodiment of the present disclosure. In this embodiment, the method is performed by a terminal. As shown in FIG. 2, the method includes the following steps S201-S203.

In S201, receiving a CSI measurement report request related to switching of the antenna switching configuration, where the CSI measurement report request is configured to indicate a measurement resource of CSI measurement configuration.

In this embodiment, the terminal may receive a CSI measurement report request, and the CSI measurement report request is related to the switching of the antenna switching configuration. That is, the CSI measurement report request is sent to realize switching of antenna switching configuration. For example, when it is required to switch antenna switching configuration, a network device may send a CSI measurement report request for the switching requirement of the antenna switching configuration, so as to obtain relevant information from the terminal for switching the antenna switching configuration.

The CSI measurement report request indicates a measurement resource configured for the CSI measurement and at least including channel measurement resources. In some embodiments, the CSI measurement report request may further include an interference measurement resource.

In S202, performing CSI measurement to obtain a CSI measurement report, where the CSI measurement report includes configuration information of antenna switching.

In this embodiment, after receiving the CSI measurement report request, the terminal may perform CSI measurement in response to the CSI measurement report request to obtain a CSI measurement report including configuration information of antenna switching.

In some embodiments, the configuration information of antenna switching includes at least one CQI or the configuration information of antenna switching includes at least one set of CQI and RI.

The CSI measurement report obtained by the terminal includes at least one CQI, or at least one set of CQI/RI. The terminal sends the CSI measurement report to the network device, and the network device may switch the antenna switching configuration according to at least one CQI or at least one set of CQI/RI included in the CSI measurement report.

In a communication system, there are network devices supporting a single TRP and/or network devices supporting a plurality of TRPs. For the network devices supporting a single TRP and the network devices supporting a plurality of TRPs, CSI measurement and calculation methods are different.

In some embodiments, for a network device supporting single TRP, performing CSI measurement to obtain a CSI measurement report S202 may be implemented through the following steps S2021 and S20211.

In S2021, for a network device supporting a single TRP, performing CSI measurement based on a channel measurement resource corresponding to the single TRP to calculate the configuration information of antenna switching to obtain the CSI measurement report.

In this embodiment, for a network device supporting a single TRP, one or a plurality of non-zero-power Channel State Information Reference Signals (NZP CSI-RSs) corresponding to the single TRP can be used as channel measurement resources to perform the CSI measurement to calculate the configuration information of the antenna switching. The one or a plurality of NZP CSI-RSs at least include latest received NZP CSI-RSs, and in one example, further includes previously received NZP CSI-RSS.

In some embodiments, the configuration information of antenna switching is obtained by performing CSI measurement and calculation using the latest received NZP CSI-RSs corresponding to the single TRP transmission.

For example, for a network device supporting a single TRP, in the case where an upper layer signaling of the CSI measurement report configures measurement restriction (channel measurement restriction timeRestrictionForChannelMeasurements and/or interference measurement restriction timeRestrictionForInterferenceMeasurements), the terminal can use the latest received NZP CSI-RSs from the single TRP to perform CSI measurement to calculate the configuration information of antenna switching.

In some embodiments, the latest received NZP CSI-RSs corresponding to the single TRP transmission and a plurality of previously received NZP CSI-RSs are used to perform CSI measurement to calculate the configuration information of antenna switching.

For example, for a network device supporting a single TRP, in the case where the upper layer signaling of the CSI measurement report configures measurement restriction (channel measurement restriction timeRestrictionForChannelMeasurements and/or interference measurement restriction timeRestrictionForInterferenceMeasurements), the terminal can use the latest received NZP CSI-RSs and previously received NZP CSI-RSs from the single TRP to perform CSI measurement to calculate the configuration information of antenna switching. Smoother CSI measurements can be achieved by using the latest received NZP CSI-RSs and the previously received NZP CSI-RSs.

In some embodiments, the configuration information of antenna switching can be calculated as follows.

In S20211, calculating the configuration information of antenna switching according to a calculation rule and a plurality of numbers of receiving antennas corresponding to antenna switching capabilities supported by the terminal.

In this embodiment, the configuration information of antenna switching is calculated according to a calculation rule and a plurality of numbers of receiving antennas corresponding to antenna switching capabilities supported by the terminal. The antenna switching capability of the terminal can indicate an antenna configuration switching mode that the terminal can support. That is, switching can be performed between various antenna configurations supported by the antenna switching capabilities of the terminal. For example, the antenna switching capability of the terminal indicates 1T1R_2T2R_4T4R, which means that the terminal supports the following antenna configuration switching: switching from one transmitting antenna and one receiving antenna to two transmitting antennas and two receiving antennas, switching from two transmitting antennas and two receiving antennas to four transmitting antennas and four receiving antennas, switching from one transmitting antenna and one receiving antenna to four transmitting antennas and four receiving antennas, switching from four transmitting antennas and four receiving antennas to two transmitting antennas and two receiving antennas, switching from four transmitting antennas and four receiving antennas to one transmitting antenna and one receiving antenna, switching from two transmitting antennas and two receiving antennas to one transmitting antenna and one receiving antenna, and the like. In addition, the antenna switching capability of the terminal can further indicate an antenna configuration rollback mode, that is, the change from a high-capability antenna configuration supported by the antenna switching capability of the terminal to a low-capability antenna configuration. For example, the antenna switching capability of the terminal indicates 1T1R_2T2R_4T4R, which means that the terminal supports the following antenna configuration rollback: rollback from four transmitting antennas and four receive antennas to two transmitting antennas and two receiving antennas, or rollback from two transmitting antennas and two receiving antennas to one transmitting antenna and one receiving antenna.

In this embodiment, the calculation rule may be predefined jointly by the network device and the terminal, or be indicated to the terminal by the network device through a high-layer signaling configuration. For example, the calculation rule may be configured by the network device via radio resource control (RRC) signaling, media access control control element (MAC CE) and other signaling.

In some embodiments, the calculation rule may include one of the following: for a group of different numbers of receiving antennas corresponding to different antenna switching capabilities supported by the terminal, respectively calculating configuration information of antenna switching corresponding to different numbers of receiving antennas. For one or a plurality of numbers of receiving antennas corresponding to the antenna switching capability configuration not greater than the configuration on the BWP of the terminal, respectively calculating the configuration information of antenna switching corresponding to different numbers of receiving antennas. For one or a plurality of numbers of receiving antennas corresponding to the antenna switching capabilities supported by the terminal and not greater than a preset number, respectively calculating the configuration information of antenna switching corresponding to different numbers of receiving antennas. For pre-configured or specified one or a plurality of numbers of receiving antennas corresponding to antenna switching capabilities supported by the terminal, respectively calculating the configuration information of antenna switching corresponding to different numbers of receiving antennas. Or for a number of receiving antennas corresponding to antenna switching capabilities supported by the terminal corresponding to a predefined switching strategy, calculating the configuration information of antenna switching.

(1) In an embodiment, for a group of different numbers of receiving antennas corresponding to different antenna switching capabilities supported by the terminal, the configuration information of antenna switching corresponding to different numbers of receiving antennas is calculated respectively.

According to a group of different numbers of receiving antennas corresponding to different antenna switching capabilities, the configuration information of antenna switching corresponding to different numbers of receiving antennas is calculated respectively. For example, if the antenna switching capabilities of the terminal indicate 1T1R_2T2R and 1T1R_2T2R_4T4R, for the antenna switching capability 1T1R_2T2R_4T4R, a set of configuration information of antenna switching is calculated according to the receiving antenna numbers 1, 2 and 4, and for the antenna switching capability 1T1R_2T2R, a set of configuration information of antenna switching is calculated according to the receiving antenna numbers 1 and 2.

(2) In another embodiment, for one or a plurality of numbers of receiving antennas corresponding to the antenna switching capability configuration not greater than the configuration on the current BWP of the terminal, the configuration information of antenna switching corresponding to different numbers of receiving antennas is calculated respectively.

For example, if the configuration on the BWP of the terminal is 2T2R and the corresponding antenna switching capability configuration is 1T1R_2T2R_4T4R, a set of configuration information of antenna switching is calculated according to the receiving antenna numbers 1 and 2.

(3) In another embodiment, for one or a plurality of numbers of receiving antennas corresponding to the antenna switching capabilities supported by the terminal and not greater than a preset number, the configuration information of antenna switching corresponding to different numbers of receiving antennas is calculated respectively.

For example, if the antenna switching capabilities of the terminal indicate 1T1R_2T2R and 1T1R_2T2R_4T4R and the preset antenna number is 4, a set of configuration information of antenna switching is calculated according to the receiving antenna numbers 1, 2 and 4.

(4) In another embodiment, for pre-configured or specified one or a plurality of numbers of receiving antennas corresponding to antenna switching capabilities supported by the terminal, the configuration information of antenna switching corresponding to different numbers of receiving antennas is calculated respectively.

For example, if the antenna switching capabilities of the terminal indicate 1T1R_2T2R and 1T1R_2T2R_4T4R and the pre-configured or specified receiving antenna numbers include receiving antenna number 1 and receiving antenna number 2, a set of configuration information of antenna switching is calculated according to the receiving antenna numbers 1 and 2.

For another example, if the antenna switching capabilities of the terminal indicate 1T1R_2T2R and 1T1R_2T2R_4T4R, a predetermined configuration is a measurement rollback mode, and the current configuration of the terminal is 4T4R, a set of configuration information of antenna switching is calculated according to the receiving antenna numbers 2 and 4.

(5) In another embodiment, for a number of receiving antennas corresponding to antenna switching capabilities supported by the terminal corresponding to a predefined switching strategy, the configuration information of antenna switching is calculated.

For example, if the predefined switching strategy is switching to antenna configuration 4T4R according to the antenna switching capability 1T1R_2T2R_4T4R supported by the terminal, the configuration information of antenna switching is calculated according to the receiving antenna number 4.

Returning back to FIG. 2, in S203, reporting the CSI measurement report to the network device.

In this embodiment, the terminal reports the obtained CSI measurement report to the network device, and the network device switches the antenna switching configuration after obtaining the CSI measurement report. Specifically, the network device may change the antenna switching configuration of the terminal based on the configuration information of antenna switching included in the CSI measurement report.

In the embodiment of the present disclosure, after receiving the CSI measurement report request, for a network device supporting a single TRP, the terminal uses the channel resource corresponding to the single TRP to perform CSI measurement and calculation to generate a CSI measurement report. The network device can switch the antenna switching configuration based on the CSI measurement report, so as to adapt to the terminals and service requirements faster and more flexibly and support the switching of the antenna switching configuration.

In some embodiments, the CSI measurement report further includes at least one of: an expected number of receiving antennas; an expected number of transmitting antennas; or an antenna switching configuration expected to switch to. The expected number of receiving antennas indicates the number of receiving antennas that the terminal expects to use, the expected number of transmitting antennas indicates the number of transmitting antennas that the terminal expects to use, and the antenna switching configuration expected to switch to indicates the antenna switching configuration that the terminal expects to use. The expected number of receiving antennas, the number of transmitting antennas or the antenna switching configuration expected to switch to is usually the number of receiving antennas, the number of transmitting antennas or the antenna switching configuration that results in better communication quality.

In this embodiment, the terminal can obtain the expected number m′ of receiving antennas according to the calculated CQI, and can obtain the expected number n′ of transmitting antennas according to RI calculation and/or transmission requirements, and can further determine the antenna switching configuration n′Tm′R expected to switch to, (that is, n′ transmitting antennas and m′ receiving antennas). The terminal may include in the CSI measurement report at least one of the expected number m′ of receiving antennas, the expected number n′ of transmitting antennas, or the antenna switching configuration n′Tm′R expected to switch to and report the above to the network device, so that the network device can switch the antenna switching configuration according to at least one of the expected number m′ of receiving antennas, the expected number n′ of transmitting antennas, or the antenna switching configuration n′Tm′R expected to switch to, included in the CSI measurement report, and the CQI.

In the embodiment of the present disclosure, at least one of the expected number m′ of receiving antennas, the expected number n′ of transmitting antennas, or the antenna switching configuration n′Tm′R expected to switch to and the configuration information of antenna switching are simultaneously reported to the network device, so that the network device can fully consider the expected number of receiving antennas, the expected number of transmitting antennas and the antenna switching configuration expected to switch to on the terminal side when switching the antenna switching configuration.

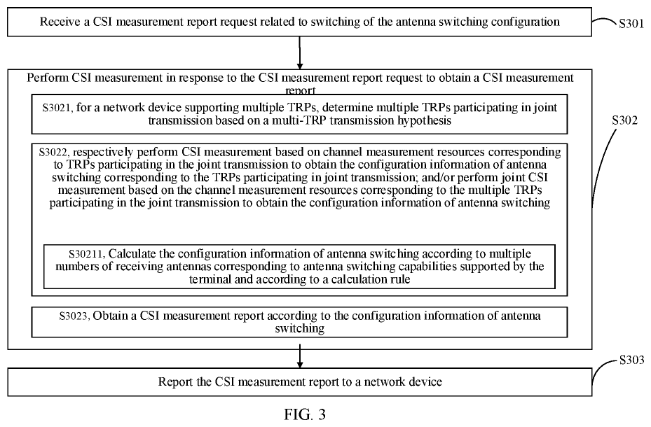

FIG. 3 shows a schematic flowchart of a method for switching an antenna switching configuration according to an embodiment of the present disclosure. In this embodiment, the method is performed by a terminal. As shown in FIG. 3, the method includes the following steps S301-S303.

In S301, receiving a CSI measurement report request related to switching of the antenna switching configuration, where the CSI measurement report request is configured to indicate a measurement resource of CSI measurement configuration.

In this embodiment, the terminal may receive a CSI measurement report request, and the CSI measurement report request is related to the switching of the antenna switching configuration, that is, the CSI measurement report request is sent to realize switching of the antenna switching configuration. For example, when it is required to switch antenna switching configuration, a network device may send a CSI measurement report request for the switching requirement of the antenna switching configuration, so as to obtain relevant information from the terminal for switching the antenna switching configuration.

The CSI measurement report request indicates a measurement resource configured for the CSI measurement and including at least channel measurement resources. In some embodiments, the CSI measurement report request may further include an interference measurement resource.

In S302, performing CSI measurement to obtain a CSI measurement report, where the CSI measurement report includes configuration information of antenna switching.

In this embodiment, after receiving the CSI measurement report request, the terminal may perform CSI measurement in response to the CSI measurement report request to obtain a CSI measurement report including configuration information of antenna switching.

In some embodiments, the configuration information of antenna switching includes at least one CQI or the configuration information of antenna switching includes at least one set of CQI and RI.

The CSI measurement report obtained by the terminal includes at least one CQI, or at least one set of CQI/RI. The terminal sends the CSI measurement report to the network device, and the network device may switch the antenna switching configuration according to at least one CQI or at least one set of CQI/RI included in the CSI measurement report.

In a communication system, there are network devices supporting a single TRP and/or network devices supporting a plurality of TRPs. For the network devices supporting a single TRP and the network devices supporting a plurality of TRPs, CSI measurement and calculation methods are different.

In some embodiments, for a network device supporting a plurality of TRPs, performing CSI measurement to obtain a CSI measurement report S302 may be implemented through the following steps S3021, S3022, and S3023.

In S3021, for a network device supporting a plurality of TRPs, determining the plurality of TRPs participating in joint transmission based on a predefined multi-TRP transmission hypothesis or a multi-TRP transmission mode configured by the network device through signaling.

For a network device supporting a plurality of TRPs, not all a plurality of TRPs participate in the joint transmission. The plurality of TRPs participating in the joint transmission can be determined according to the multi-TRP transmission hypothesis or according to the multi-TRP transmission mode configured by the network device through signaling.

In some embodiments, for example, there are a plurality of TRPs: TRP1, TRP2, TRP3, and TRP4, and the multi-TRP transmission mode configured by the network device through signaling is implemented in combination with TRP1, TRP2, and TRP4, the plurality of TRPs participating in the joint transmission can be determined as TRP1, TRP2 and TRP4.

In some embodiments, the multi-TRP transmission hypothesis may include one of: a multi-TRP transmission mode of a most recently scheduled downlink channel; or a multi-TRP transmission mode of a predefined downlink channel.

For example, there are a plurality of TRPs: TRP1, TRP2, TRP3 and TRP4. In some embodiments, a plurality of TRPs participating in the joint transmission can be determined according to the multi-TRP transmission mode of the most recently scheduled downlink channel. For example, if the multi-TRP transmission mode of the most recently scheduled downlink channel is implemented in combination with TRP1 and TRP2, the plurality of TRPs participating in the joint transmission can be determined as TRP1 and TRP2. If the multi-TRP transmission mode of the most recently scheduled downlink channel is implemented in combination with TRP1 and TRP3, the plurality of TRPs participating in the joint transmission can be determined as TRP1 and TRP3. In some other embodiments, a plurality of TRPs participating in the joint transmission can be determined according to the multi-TRP transmission mode of a predefined downlink channel. For example, if the multi-TRP transmission mode of the predefined downlink channel is implemented in combination with TRP1 and TRP2, the plurality of TRPs participating in the joint transmission can be determined as TRP1 and TRP2. If the multi-TRP transmission mode of the predefined downlink channel is implemented in combination with TRP2 and TRP3, the plurality of TRPs participating in the joint transmission can be determined as TRP2 and TRP3.

In some embodiments, the above-mentioned downlink channel may be a PDSCH, a PDCCH or other downlink channels.

Next, in S3022, respectively performing CSI measurement based on channel measurement resources corresponding to TRPs participating in the joint transmission to calculate the configuration information of antenna switching corresponding to the TRPs participating in joint transmission; and/or performing joint CSI measurement based on the channel measurement resources corresponding to the a plurality of TRPs participating in the joint transmission to calculate the configuration information of antenna switching.

In this embodiment, for a network device supporting a plurality of TRPs, the CSI measurement can be performed as follows.

In the first way: for TRPs participating in the joint transmission, based on the channel measurement resources corresponding to the TRPs, CSI measurement is performed respectively to calculate the configuration information of antenna switching corresponding to the TRPs participating in the joint transmission.

For example, if TRP1 and TRP2 are determined to participate in the joint transmission, CSI measurement is performed respectively based on the channel measurement resource corresponding to TRP1 and based on the channel measurement resource corresponding to TRP2 to calculate the configuration information of antenna switching.

For example, for TRP1, one or a plurality of NZP CSI-RSs corresponding to TRP1 are used as channel measurement resources to perform CSI measurement to calculate the configuration information of antenna switching corresponding to TRP1. The one or a plurality of NZP CSI-RSs at least include latest received NZP CSI-RSs, and in one example, further include previously received NZP CSI-RSs.

For TRP2, one or a plurality of NZP CSI-RSs corresponding to TRP2 are used as channel measurement resources to perform CSI measurement to calculate the configuration information of antenna switching corresponding to TRP2.

In the second way: based on the channel measurement resources corresponding to the plurality of TRPs participating in the joint transmission, the joint CSI measurement is performed to calculate the configuration information of antenna switching.

For example, if TRP1 and TRP2 are determined to participate in the joint transmission, the joint CSI measurement is performed based on channel measurement resources corresponding to TRP1 and TRP2 to calculate the configuration information of antenna switching.

In the third way: CSI measurement and calculation are performed by combining the first way and the second way.

In this way, CSI measurement is performed respectively based on the channel measurement resources corresponding to the TRPs, and joint CSI measurement is performed based on the channel measurement resources corresponding to a plurality of TRPs participating in the joint transmission, so as to calculate the configuration information of antenna switching.

For example, if TRP1 and TRP2 are determined to participate in the joint transmission, CSI measurement is respectively performed based on the channel measurement resource corresponding to TRP1 and based on the channel measurement resource corresponding to TRP2 and joint CSI measurement is performed based on the channel measurement resources corresponding to TRP1 and TRP2, so to calculate the configuration information for antenna switching.

In some embodiments, the configuration information of antenna switching can be calculated as follows.

In S30221, calculating the configuration information of antenna switching according to a calculation rule and a plurality of numbers of receiving antennas corresponding to antenna switching capabilities supported by the terminal.

In this embodiment, the configuration information of antenna switching is calculated according to a calculation rule and a plurality of numbers of receiving antennas corresponding to antenna switching capabilities supported by the terminal. The antenna switching capability of the terminal can indicate an antenna configuration switching mode that the terminal can support. That is, switching can be performed between various antenna configurations supported by the antenna switching capabilities of the terminal. For example, the antenna switching capability of the terminal indicates 1T1R_2T2R_4T4R, which means that the terminal supports the following antenna configuration switching: switching from one transmitting antenna and one receiving antenna to two transmitting antennas and two receiving antennas, switching from two transmitting antennas and two receiving antennas to four transmitting antennas and four receiving antennas, and switching from one transmitting antenna and one receiving antenna to four transmitting antennas and four receiving antennas, switching from four transmitting antennas and four receiving antennas to two transmitting antennas and two receiving antennas, switching from four transmitting antennas and four receiving antennas to one transmitting antenna and one receiving antenna, switching from two transmitting antennas and two receiving antennas to one transmitting antenna and one receiving antenna, and the like. In addition, the antenna switching capability of the terminal can further indicate an antenna configuration rollback mode, that is, the change from a high-capability antenna configuration supported by the antenna switching capability of the terminal to a low-capability antenna configuration. For example, the antenna switching capability of the terminal indicates 1T1R_2T2R_4T4R, which means that the terminal supports the following antenna configuration rollback: rollback from four transmitting antennas and four receive antennas to two transmitting antennas and two receiving antennas, or rollback from two transmitting antennas and two receiving antennas to one transmitting antenna and one receiving antenna.

In this embodiment, the calculation rule may be predefined jointly by the network device and the terminal, or be indicated to the terminal by the network device through a high-layer signaling configuration. For example, the calculation rule may be configured by the network device via radio resource control (RRC) signaling, media access control control element (MAC CE) and other signaling.

In some embodiments, the calculation rule may include one of the following: for a group of different numbers of receiving antennas corresponding to different antenna switching capabilities supported by the terminal, respectively calculating configuration information of antenna switching corresponding to different numbers of receiving antennas. For one or a plurality of numbers of receiving antennas corresponding to the antenna switching capability configuration not greater than the configuration on the BWP of the terminal, respectively calculating the configuration information of antenna switching corresponding to different numbers of receiving antennas. For one or a plurality of numbers of receiving antennas corresponding to the antenna switching capabilities supported by the terminal and not greater than a preset number, respectively calculating the configuration information of antenna switching corresponding to different numbers of receiving antennas. For pre-configured or specified one or a plurality of numbers of receiving antennas corresponding to antenna switching capabilities supported by the terminal, respectively calculating the configuration information of antenna switching corresponding to different numbers of receiving antennas. Or for a number of receiving antennas corresponding to antenna switching capabilities supported by the terminal corresponding to a predefined switching strategy, calculating the configuration information of antenna switching.

(1) In an embodiment, for a group of different numbers of receiving antennas corresponding to different antenna switching capabilities supported by the terminal, the configuration information of antenna switching corresponding to different numbers of receiving antennas is calculated respectively.

According to a group of different numbers of receiving antennas corresponding to different antenna switching capabilities, the configuration information of antenna switching is calculated respectively. For example, if the antenna switching capabilities of the terminal indicate 1T1R_2T2R and 1T1R_2T2R_4T4R, for the antenna switching capability 1T1R_2T2R_4T4R, a set of configuration information of antenna switching is calculated according to the receiving antenna numbers 1, 2, and 4, and for the antenna switching capability 1T1R_2T2R, a set of configuration information of antenna switching is calculated according to the receiving antenna numbers 1 and 2.

(2) In another embodiment, for one or a plurality of numbers of receiving antennas corresponding to the antenna switching capability configuration not greater than the configuration on the current BWP of the terminal, the configuration information of antenna switching corresponding to different numbers of receiving antennas is calculated respectively.

For example, if the configuration on the BWP of the terminal is 2T2R and the corresponding antenna switching capability configuration is 1T1R_2T2R_4T4R, a set of configuration information of antenna switching is calculated according to the receiving antenna numbers 1 and 2.

(3) In another embodiment, for one or a plurality of numbers of receiving antennas corresponding to the antenna switching capabilities supported by the terminal and not greater than a preset number, the configuration information of antenna switching corresponding to different numbers of receiving antennas is calculated respectively.

For example, if the antenna switching capabilities of the terminal indicate 1T1R_2T2R and 1T1R_2T2R_4T4R and the preset antenna number is 4, a set of configuration information of antenna switching is calculated according to the receiving antenna numbers 1, 2 and 4.

(4) In another embodiment, for pre-configured or specified one or a plurality of numbers of receiving antennas corresponding to antenna switching capabilities supported by the terminal, the configuration information of antenna switching corresponding to different numbers of receiving antennas is calculated respectively.

For example, if the antenna switching capabilities of the terminal indicate 1T1R_2T2R and 1T1R_2T2R_4T4R and the pre-configured or specified receiving antenna numbers include receiving antenna number 1 and receiving antenna number 2, a set of configuration information of antenna switching is calculated according to the receiving antenna numbers 1 and 2.

For another example, if the antenna switching capabilities of the terminal indicate 1T1R_2T2R and 1T1R_2T2R_4T4R, a predetermined configuration is a measurement rollback mode, and the current configuration of the terminal is 4T4R, a set of configuration information of antenna switching is calculated according to the receiving antenna numbers 2 and 4.

(5) In another embodiment, for a number of receiving antennas corresponding to antenna switching capabilities supported by the terminal corresponding to a predefined switching strategy, the configuration information of antenna switching is calculated.

For example, if the predefined switching strategy is switching to antenna configuration 4T4R according to the antenna switching capability 1T1R_2T2R_4T4R supported by the terminal, the configuration information of antenna switching is calculated according to the receiving antenna number 4.

In S3023, obtaining a CSI measurement report according to the configuration information of antenna switching.

After the configuration information of antenna switching is calculated, a CSI measurement report can be obtained according to the calculated configuration information of antenna switching.

In S303, reporting the CSI measurement report to the network device.

In this embodiment, the terminal reports the obtained CSI measurement report to the network device, and the network device switches the antenna switching configuration after obtaining the CSI measurement report. Specifically, the network device may change the antenna switching configuration of the terminal based on the configuration information of antenna switching included in the CSI measurement report.

In the embodiment of the present disclosure, after receiving the CSI measurement report request, for a network device supporting a plurality of TRPs, the terminal may perform CSI measurement and calculation in many different ways to generate a CSI measurement report, and the network device can switch the antenna switching configuration based on the CSI measurement report, so as to adapt to the terminals and service requirements faster and more flexibly and support the switching of the antenna configuration.

In some embodiments, the CSI measurement report further includes at least one of: an expected number of receiving antennas; an expected number of transmitting antennas; or an antenna switching configuration expected to switch to. The expected number of receiving antennas indicates the number of receiving antennas that the terminal expects to use, the expected number of transmitting antennas indicates the number of transmitting antennas that the terminal expects to use, and the antenna switching configuration expected to switch to indicates the antenna switching configuration that the terminal expects to use. The expected number of receiving antennas, the number of transmitting antennas or the antenna switching configuration expected to switch to is usually the number of receiving antennas, the number of transmitting antennas or the antenna switching configuration that results in better communication quality.

In this embodiment, the terminal can obtain the expected number m′ of receiving antennas according to the calculated CQI, and can obtain the expected number n′ of transmitting antennas according to RI calculation and/or transmission requirements, and can further determine the antenna switching configuration n′Tm′R expected to switch to, (that is, n′ transmitting antennas and m′ receiving antennas). The terminal may include in the CSI measurement report at least one of the expected number m′ of receiving antennas, the expected number n′ of transmitting antennas, or the antenna switching configuration n′Tm′R expected to switch to and report the above to the network device, so that the network device can switch the antenna switching configuration according to at least one of the expected number m′ of receiving antennas, the expected number n′ of transmitting antennas, or the antenna switching configuration n′Tm′R expected to switch to, included in the CSI measurement report, and the CQI.

In the embodiment of the present disclosure, at least one of the expected number m′ of receiving antennas, the expected number n′ of transmitting antennas, or the antenna switching configuration n′Tm′R expected to switch to and the configuration information of antenna switching are simultaneously reported to the network device. So that the network device can fully consider the expected number of receiving antennas/the expected number of transmitting antennas/the antenna switching configuration expected to switch to on the terminal side when switching the antenna switching configuration.

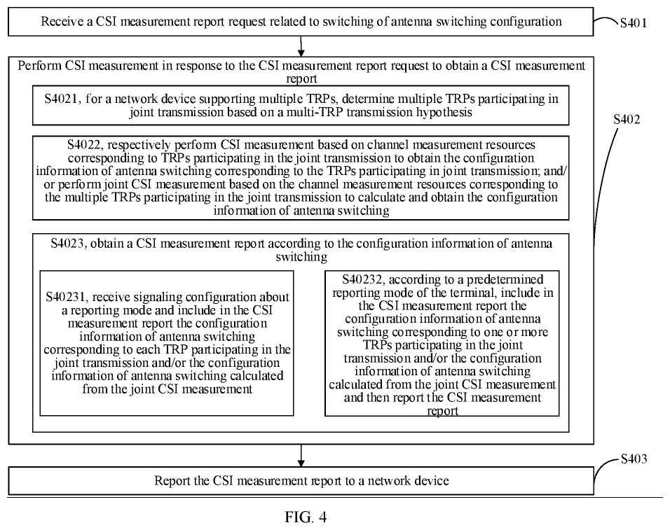

FIG. 4 shows a schematic flowchart of a method for switching an antenna switching configuration according to an embodiment of the present disclosure. In this embodiment, the method is performed by a terminal. As shown in FIG. 4, the method includes the following steps S401-S403.

In S401, receiving a CSI measurement report request related to switching of the antenna switching configuration, where the CSI measurement report request is configured to indicate a measurement resource of CSI measurement configuration.

In this embodiment, the terminal may receive a CSI measurement report request, and the CSI measurement report request is related to the switching of the antenna switching configuration, that is, the CSI measurement report request is sent to realize switching of the antenna switching configuration. For example, when it is required to switch the antenna switching configuration, a network device may send a CSI measurement report request for the switching requirement of the antenna switching configuration, so as to obtain relevant information from the terminal for switching the antenna switching configuration.

The CSI measurement report request indicates a measurement resource configured for the CSI measurement and at least including channel measurement resources. In some embodiments, the CSI measurement report request may further include an interference measurement resource.

In S402, performing CSI measurement to obtain a CSI measurement report, where the CSI measurement report includes configuration information of antenna switching.

In this embodiment, after receiving the CSI measurement report request, the terminal may perform CSI measurement in response to the CSI measurement report request to obtain a CSI measurement report including configuration information of antenna switching.

In some embodiments, the configuration information of antenna switching includes at least one CQI or the configuration information of antenna switching includes at least one set of CQI and RI.

In a communication system, there are network devices supporting a single TRP and/or network devices supporting a plurality of TRPs. For the network devices supporting a single TRP and the network devices supporting a plurality of TRPs, CSI measurement and calculation methods are different.

In some embodiments, for a network device supporting a plurality of TRPs, performing CSI measurement to obtain a CSI measurement report S402 may be implemented through the following steps S4021, S4022 and S4023.

In S4021, for a network device supporting a plurality of TRPs, determining the plurality of TRPs participating in joint transmission based on a multi-TRP transmission hypothesis.

For a network device supporting a plurality of TRPs, not all a plurality of TRPs participate in the joint transmission. The plurality of TRPs participating in the joint transmission can be determined according to the multi-TRP transmission hypothesis.

In some embodiments, the multi-TRP transmission hypothesis may include one of: a multi-TRP transmission mode of a most recently scheduled downlink channel; or a multi-TRP transmission mode of a predefined downlink channel.

In some embodiments, the above-mentioned downlink channel may be a PDSCH, a PDCCH or other downlink channels.

In S4022, respectively performing CSI measurement based on channel measurement resources corresponding to TRPs participating in the joint transmission to calculate the configuration information of antenna switching corresponding to the TRPs participating in joint transmission; and/or performing joint CSI measurement based on the channel measurement resources corresponding to the a plurality of TRPs participating in the joint transmission to calculate the configuration information of antenna switching.

In this embodiment, for a network device supporting a plurality of TRPs, the CSI measurement can be performed as follows.

In the first way: for TRPs participating in the joint transmission, based on the channel measurement resources corresponding to the TRPs, CSI measurement is performed respectively to calculate the configuration information of antenna switching.

In the second way: based on the channel measurement resources corresponding to the plurality of TRPs participating in the joint transmission, the joint CSI measurement is performed to calculate the configuration information of antenna switching.

In the third way: CSI measurement and calculation are performed by combining the first way and the second way.

In S4023, obtaining a CSI measurement report according to the configuration information of antenna switching.

After the configuration information of antenna switching is calculated, a CSI measurement report can be obtained according to the calculated configuration information of antenna switching.

Specifically, the CSI measurement report can be obtained according to any of the following steps S40231 and S40232.

In S40231, receiving signaling configuration about the reporting mode and including in the CSI measurement report the configuration information of antenna switching corresponding to each TRP participating in the joint transmission and/or the configuration information of antenna switching calculated from the joint CSI measurement.

In this embodiment, the terminal determines how to generate the CSI measurement report according to the signaling configuration of the network device. The signaling configuration of the network device may instruct the terminal to report the CSI measurement report as follows.

(1) The terminal can report the configuration information of antenna switching corresponding to each TRP participating in the joint transmission.

For example, after performing CSI measurement for TRP1 and TRP2 participating in the joint transmission to calculate the configuration information of antenna switching corresponding to TRP1 and the configuration information of antenna switching corresponding to TRP2, the terminal can include all the calculated configuration information of antenna switching in the CSI measurement report and report the CSI measurement report to the network device, that is, the configuration information of antenna switching corresponding to TRP1 and the configuration information of antenna switching corresponding to TRP2 are reported to the network device.

(2) The terminal can report the configuration information of antenna switching calculated from joint CSI measurement for a plurality of TRPs participating in the joint transmission.

For example, after performing joint CSI measurement for TRP1 and TRP2 participating in the joint transmission to calculate the configuration information of antenna switching, the terminal can include the calculated configuration information of antenna switching in the CSI measurement report and report the CSI measurement report to the network device.

(3) The terminal can report the configuration information of antenna switching corresponding to each TRP participating in the joint transmission and the configuration information of antenna switching calculated from the joint CSI measurement for a plurality of TRPs participating in the joint transmission.

For example, the terminal can include in the CSI measurement report the configuration information of antenna switching corresponding to TRP1, the configuration information of antenna switching corresponding to TRP2, and the configuration information of antenna switching calculated from the joint CSI measurement for TRP1 and TRP2 participating in joint transmission and report the CSI measurement report to the network device.

In S40232, according to a predetermined reporting mode of the terminal, including in the CSI measurement report the configuration information of antenna switching corresponding to one or a plurality of TRPs participating in the joint transmission and/or the configuration information of antenna switching calculated from the joint CSI measurement and reporting the CSI measurement report.

In this embodiment, the terminal determines how to generate the CSI measurement report according to a predetermined reporting mode. The predetermined reporting mode may instruct the terminal to report the CSI measurement report as follows.

(1) The terminal can report the configuration information of antenna switching corresponding to one or a plurality of TRPs participating in the joint transmission.

For example, after respectively performing CSI measurement for TRP1 and TRP2 participating in the joint transmission to calculate the configuration information of antenna switching corresponding to TRP1 and the configuration information of antenna switching corresponding to TRP2, the terminal may select one or a plurality of pieces from all the calculated configuration information of antenna switching to include in the CSI measurement report and report the CSI measurement report to the network device.

In some embodiments, the terminal may select part of the configuration information of antenna switching to include in the CSI measurement report and report the CSI measurement report to the network device, for example, report the configuration information of antenna switching corresponding to TRP1 to the network device.

In some embodiments, the terminal may select all the configuration information of antenna switching to include in the CSI measurement report and report the CSI measurement report to the network device, for example, report the configuration information of antenna switching corresponding to TRP1 and the configuration information of antenna switching corresponding to TRP2 to the network device.

(2) The terminal can report the configuration information of antenna switching calculated from joint CSI measurement for a plurality of TRPs participating in the joint transmission.

For example, after performing joint CSI measurement for TRP1 and TRP2 participating in the joint transmission to calculate the configuration information of antenna switching, the terminal can include the calculated configuration information of antenna switching in the CSI measurement report and report the CSI measurement report to the network device.

(3) The terminal can report the configuration information of antenna switching corresponding to one or a plurality of TRPs participating in the joint transmission and the configuration information of antenna switching calculated from the joint CSI measurement for a plurality of TRPs participating in the joint transmission.

For example, the terminal can include in the CSI measurement report the configuration information of antenna switching corresponding to TRP1, the configuration information of antenna switching corresponding to TRP2, and the configuration information of antenna switching calculated from the joint CSI measurement for TRP1 and TRP2 participating in joint transmission and report the CSI measurement report to the network device.

For another example, the terminal can include in the CSI measurement report the configuration information of antenna switching corresponding to TRP1 and the configuration information of antenna switching calculated from joint CSI measurement for TRP1 and TRP2 participating in the joint transmission and report the CSI measurement report to the network device.

In S403, reporting the CSI measurement report to the network device.

In this embodiment, the terminal reports the obtained CSI measurement report to the network device, and the network device switches the antenna switching configuration after obtaining the CSI measurement report. Specifically, the network device may change the antenna switching configuration of the terminal based on the configuration information of antenna switching included in the CSI measurement report.

In the embodiment of the present disclosure, after receiving the CSI measurement report request, for a network device supporting a plurality of TRPs, the terminal may perform CSI measurement and calculation in many different ways to generate a CSI measurement report, and the network device can switch the antenna switching configuration based on the CSI measurement report, so as to adapt to the terminals and service requirements faster and more flexibly and support the switching of the antenna configuration.

In some embodiments, the CSI measurement report further includes at least one of: an expected number of receiving antennas; an expected number of transmitting antennas; or an antenna switching configuration expected to switch to. The expected number of receiving antennas indicates the number of receiving antennas that the terminal expects to use, the expected number of transmitting antennas indicates the number of transmitting antennas that the terminal expects to use, and the antenna switching configuration expected to switch to indicates the antenna switching configuration that the terminal expects to use. The expected number of receiving antennas, the number of transmitting antennas or the antenna switching configuration expected to switch to is usually the number of receiving antennas, the number of transmitting antennas or the antenna switching configuration that results in better communication quality.

In this embodiment, the terminal can obtain the expected number m′ of receiving antennas according to the calculated CQI, and can obtain the expected number n′ of transmitting antennas according to RI calculation and/or transmission requirements, and can further determine the antenna switching configuration n′Tm′R expected to switch to, (that is, n′ transmitting antennas and m′ receiving antennas). The terminal may include in the CSI measurement report at least one of the expected number m′ of receiving antennas, the expected number n′ of transmitting antennas, or the antenna switching configuration n′Tm′R expected to switch to and report the above to the network device, so that the network device can switch the antenna switching configuration according to at least one of the expected number m′ of receiving antennas, the expected number n′ of transmitting antennas, or the antenna switching configuration n′Tm′R expected to switch to, included in the CSI measurement report, and the CQI.

In the embodiment of the present disclosure, at least one of the expected number m′ of receiving antennas, the expected number n′ of transmitting antennas, or the antenna switching configuration n′Tm′R expected to switch to and the configuration information of antenna switching are simultaneously reported to the network device, so that the network device can fully consider the expected number of receiving antennas, the expected number of transmitting antennas and the antenna switching configuration expected to switch to on the terminal side when switching the antenna switching configuration.

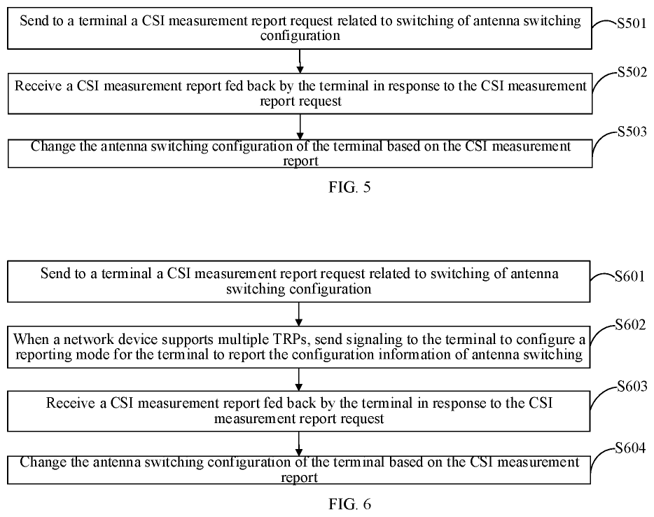

FIG. 5 shows a schematic flowchart of a method for switching an antenna switching configuration according to an embodiment of the present disclosure. In this embodiment, the method is performed by a network device, the network device may be a base station, and the base station may include a plurality of cells providing services for a terminal device. Depending on different specific applications, the base station may also be called an access point, or may be a device in an access network that communicates with a wireless terminal device through one or a plurality of sectors on an air interface, or may be called other names. As shown in FIG. 5, the method for switching an antenna switching configuration includes the following steps S501-S503.

S501. Sending to a terminal a CSI measurement report request related to switching of antenna switching configuration, where the CSI measurement report request is configured to indicate a measurement resource of CSI measurement configuration.

In this embodiment, when switching of the antenna switching configuration is required, the network device can send a CSI measurement report request in response to the switching requirement of the antenna switching configuration, that is, the CSI measurement report request is sent for the switching of antenna switching configuration, so as to obtain relevant information from the terminal for performing the switching of antenna switching configuration.

The CSI measurement report request indicates a measurement resource configured for the CSI measurement and at least including channel measurement resources. In some embodiments, the CSI measurement report request may further include an interference measurement resource.

In S502, receiving the CSI measurement report sent by the terminal, where the CSI measurement report includes configuration information of antenna switching.

In this embodiment, the network device receives from the terminal the CSI measurement report fed back by the terminal in response to the CSI measurement report request. After receiving the CSI measurement report request, the terminal may perform CSI measurement in response to the CSI measurement report request to obtain a CSI measurement report including the configuration information of antenna switching and feed the CSI measurement report back to the network device.

In some embodiments, the configuration information of antenna switching includes at least one CQI or the configuration information of antenna switching includes at least one set of CQI and RI.

The CSI measurement report obtained by the terminal may include at least one CQI, or include at least one set of CQI/RI. Specifically, as described below, the network device may switch the antenna switching configuration according to at least one CQI or at least one set of CQI/RI included in the CSI measurement report.

In a communication system, there are network devices supporting a single TRP and/or network devices supporting a plurality of TRPs. For the network devices supporting a single TRP and the network devices supporting a plurality of TRPs, CSI measurement and calculation methods are different.

In some embodiments, when the network device supports a single TRP, the CSI measurement report can be obtained according to the configuration information of antenna switching calculated by performing CSI measurement based on a channel measurement resource corresponding to the TRP.

In this embodiment, when the network device supports a single TRP, the configuration information of antenna switching can be calculated from the CSI measurement using one or a plurality of NZP CSI-RSs corresponding to the single TRP as channel measurement resources. The one or a plurality of NZP CSI-RSs at least include latest received NZP CSI-RSs, and in one example, further include previously received NZP CSI-RSs.

In some embodiments, the configuration information of antenna switching is obtained by performing CSI measurement and calculation using the latest received NZP CSI-RSs corresponding to the single TRP transmission.

For example, for a network device supporting a single TRP, in the case where the upper layer signaling of the CSI measurement report configures measurement restriction (channel measurement restriction timeRestrictionForChannelMeasurements and/or interference measurement restriction timeRestrictionForInterferenceMeasurements), the terminal can use the latest received NZP CSI-RSs from the single TRP to perform CSI measurement to calculate the configuration information of antenna switching.

In some embodiments, the latest received NZP CSI-RSs corresponding to the single TRP transmission and a plurality of previously received NZP CSI-RSs are used to perform CSI measurement to calculate the configuration information of antenna switching.

For example, for a network device supporting a single TRP, in the case where the upper layer signaling of the CSI measurement report configures measurement restriction (channel measurement restriction timeRestrictionForChannelMeasurements and/or interference measurement restriction timeRestrictionForInterferenceMeasurements), the terminal can use the latest received NZP CSI-RSs and previously received NZP CSI-RSs from the single TRP to perform CSI measurement to calculate the configuration information of antenna switching. Smoother CSI measurements can be achieved by using the latest received NZP CSI-RSs and the previously received NZP CSI-RSs.

In some embodiments, when the network device supports a plurality of TRPs, the CSI measurement report can be generated according to the configuration information of antenna switching in the following: configuration information of antenna switching corresponding to the TRPs participating in joint transmission, calculated by respectively performing CSI measurement based on channel measurement resources corresponding to the TRPs participating in the joint transmission; and/or the configuration information of antenna switching calculated by performing joint CSI measurement based on the channel measurement resources corresponding to the a plurality of TRPs participating in the joint transmission. The TRPs participating in the joint transmission are determined by a predefined multi-TRP transmission hypothesis or a multi-TRP transmission mode configured by the network device through signaling.

In this embodiment, when the network device supports a plurality of TRPs, not all the plurality of TRPs participate in the joint transmission. The plurality of TRPs participating in the joint transmission can be determined according to the multi-TRP transmission hypothesis or according to the multi-TRP transmission mode configured by the network device through signaling.

In some embodiments, for example, there are a plurality of TRPs: TRP1, TRP2, TRP3and TRP4, and the multi-TRP transmission mode configured by the network device through signaling is implemented in combination with TRP1, TRP2, and TRP4, the plurality of TRPs participating in the joint transmission can be determined as TRP1, TRP2 and TRP4.

In some embodiments, the multi-TRP transmission hypothesis may include one of: a multi-TRP transmission mode of a most recently scheduled downlink channel; or a multi-TRP transmission mode of a predefined downlink channel.

For example, there are a plurality of TRPs: TRP1, TRP2, TRP3 and TRP4. In some embodiments, a plurality of TRPs participating in the joint transmission can be determined according to the multi-TRP transmission mode of the most recently scheduled downlink channel. For example, if the multi-TRP transmission mode of the most recently scheduled downlink channel is implemented in combination with TRP1 and TRP2, the plurality of TRPs participating in the joint transmission can be determined as TRP1 and TRP2. If the multi-TRP transmission mode of the most recently scheduled downlink channel is implemented in combination with TRP1 and TRP3, the plurality of TRPs participating in the joint transmission can be determined as TRP1 and TRP3. In some other embodiments, a plurality of TRPs participating in the joint transmission can be determined according to the multi-TRP transmission mode of a predefined downlink channel. For example, if the multi-TRP transmission mode of the predefined downlink channel is implemented in combination with TRP1 and TRP2, the plurality of TRPs participating in the joint transmission can be determined as TRP1 and TRP2. If the multi-TRP transmission mode of the predefined downlink channel is implemented by in combination with TRP2 and TRP3, the plurality of TRPs participating in the joint transmission can be determined as TRP2 and TRP3.

In some embodiments, the above-mentioned downlink channel may be a PDSCH, a PDCCH or other downlink channels.

After the a plurality of TRPs participating in the joint transmission are determined, CSI measurement can be performed respectively based on channel measurement resources corresponding to the TRPs participating in the joint transmission to calculate the configuration information of antenna switching corresponding to the TRPs participating in joint transmission; and/or joint CSI measurement is performed based on the channel measurement resources corresponding to the a plurality of TRPs participating in the joint transmission to calculate the configuration information of antenna switching.

For example, the CSI measurement can be performed as follows.

In the first way: for TRPs participating in the joint transmission, based on the channel measurement resources corresponding to the TRPs, CSI measurement is performed respectively to calculate the configuration information of antenna switching.

For example, if TRP1 and TRP2 are determined to participate in the joint transmission, CSI measurement is performed respectively based on the channel measurement resource corresponding to TRP1 and based on the channel measurement resource corresponding to TRP2 to calculate the configuration information of antenna switching.

For example, for TRP1, one or a plurality of NZP CSI-RSs corresponding to TRP1 are used as channel measurement resources to perform CSI measurement to calculate the configuration information of antenna switching corresponding to TRP1. The one or a plurality of NZP CSI-RSs at least include latest received NZP CSI-RSs, and in one example , further include previously received NZP CSI-RSs.

For TRP2, one or a plurality of NZP CSI-RSs corresponding to TRP2 are used as channel measurement resources to perform CSI measurement to calculate the configuration information of antenna switching corresponding to TRP2.

In the second way: based on the channel measurement resources corresponding to the plurality of TRPs participating in the joint transmission, the joint CSI measurement is performed to calculate the configuration information of antenna switching.

For example, if TRP1 and TRP2 are determined to participate in the joint transmission, the joint CSI measurement is performed based on channel measurement resources corresponding to TRP1 and TRP2 to calculate the configuration information of antenna switching.

In the third way: CSI measurement and calculation are performed by combining the first way and the second way.

In this way, CSI measurement is performed respectively based on the channel measurement resources corresponding to the TRPs, and joint CSI measurement is performed based on the channel measurement resources corresponding to a plurality of TRPs participating in the joint transmission, so as to calculate the configuration information of antenna switching.

For example, if TRP1 and TRP2 are determined to participate in the joint transmission, CSI measurement is respectively performed based on the channel measurement resource corresponding to TRP1 and based on the channel measurement resource corresponding to TRP2 and joint CSI measurement is performed based on the channel measurement resources corresponding to TRP1 and TRP2, so as to calculate the configuration information of antenna switching.

In some embodiments, the configuration information of antenna switching is calculated according to a calculation rule and a plurality of numbers of receiving antennas corresponding to antenna switching capabilities supported by the terminal.

In this embodiment, the configuration information of antenna switching is calculated according to a calculation rule and a plurality of numbers of receiving antennas corresponding to antenna switching capabilities supported by the terminal. The antenna switching capability of the terminal can indicate an antenna configuration switching mode that the terminal can support, that is, switching can be performed between various antenna configurations supported by the antenna switching capabilities of the terminal. For example, the antenna switching capability of the terminal indicates 1T1R_2T2R_4T4R, which means that the terminal supports the following antenna configuration switching: switching from one transmitting antenna and one receiving antenna to two transmitting antennas and two receiving antennas, switching from two transmitting antennas and two receiving antennas to four transmitting antennas and four receiving antennas, switching from one transmitting antenna and one receiving antenna to four transmitting antennas and four receiving antennas, switching from four transmitting antennas and four receiving antennas to two transmitting antennas and two receiving antennas, switching from four transmitting antennas and four receiving antennas to one transmitting antenna and one receiving antenna, switching from two transmitting antennas and two receiving antennas to one transmitting antenna and one receiving antenna, and on the like. In addition, the antenna switching capability of the terminal can also indicate an antenna configuration rollback mode, that is, the change from a high-capability antenna configuration supported by the antenna switching capability of the terminal to a low-capability antenna configuration. For example, the antenna switching capability of the terminal indicates 1T1R_2T2R_4T4R, which means that the terminal supports the following antenna configuration rollback: rollback from four transmitting antennas and four receive antennas to two transmitting antennas and two receiving antennas, and rollback from two transmitting antennas and two receiving antennas to one transmitting antenna and one receiving antenna.

In this embodiment, the calculation rule may be predefined jointly by the network device and the terminal, or be indicated to the terminal by the network device through a high-layer signaling configuration. For example, the calculation rule may be configured by the network device via radio resource control (RRC) signaling, media access control control element (MAC CE) and other signaling.

In some embodiments, the calculation rule may include one of the following: for a group of different numbers of receiving antennas corresponding to different antenna switching capabilities supported by the terminal, respectively calculating configuration information of antenna switching corresponding to different numbers of receiving antennas. For one or a plurality of numbers of receiving antennas corresponding to the antenna switching capability configuration not greater than the configuration on the BWP of the terminal, respectively calculating the configuration information of antenna switching corresponding to different numbers of receiving antennas. For one or a plurality of numbers of receiving antennas corresponding to the antenna switching capabilities supported by the terminal and not greater than a preset number, respectively calculating the configuration information of antenna switching corresponding to different numbers of receiving antennas. For pre-configured or specified one or a plurality of numbers of receiving antennas corresponding to antenna switching capabilities supported by the terminal, respectively calculating the configuration information of antenna switching corresponding to different numbers of receiving antennas. Or for a number of receiving antennas corresponding to antenna switching capabilities supported by the terminal corresponding to a predefined switching strategy, calculating the configuration information of antenna switching.

(1) In an embodiment, for a group of different numbers of receiving antennas corresponding to different antenna switching capabilities supported by the terminal, the configuration information of antenna switching corresponding to different numbers of receiving antennas is calculated respectively.

According to a group of different numbers of receiving antennas corresponding to different antenna switching capabilities, the configuration information of antenna switching is calculated respectively. For example, if the antenna switching capabilities of the terminal indicate 1T1R_2T2R and 1T1R_2T2R_4T4R, for the antenna switching capability 1T1R_2T2R_4T4R, a set of configuration information of antenna switching is calculated according to the receiving antenna numbers 1, 2, and 4, and for the antenna switching capability 1T1R_2T2R, a set of configuration information of antenna switching is calculated according to the receiving antenna numbers 1 and 2.

(2) In another embodiment, for one or a plurality of numbers of receiving antennas corresponding to the antenna switching capability configuration not greater than the configuration on the current BWP of the terminal, the configuration information of antenna switching corresponding to different numbers of receiving antennas is calculated respectively.

For example, if the configuration on the BWP of the terminal is 2T2R and the corresponding antenna switching capability configuration is 1T1R_2T2R_4T4R, a set of configuration information of antenna switching is calculated according to the receiving antenna numbers 1 and 2.

(3) In another embodiment, for one or a plurality of numbers of receiving antennas corresponding to the antenna switching capabilities supported by the terminal and not greater than a preset number, the configuration information of antenna switching corresponding to different numbers of receiving antennas is calculated respectively.

For example, if the antenna switching capabilities of the terminal indicate 1T1R_2T2R and 1T1R_2T2R_4T4R and the preset antenna number is 4, a set of configuration information of antenna switching is calculated according to the receiving antenna numbers 1, 2 and 4.

(4) In another embodiment, for pre-configured or specified one or a plurality of numbers of receiving antennas corresponding to antenna switching capabilities supported by the terminal, the configuration information of antenna switching corresponding to different numbers of receiving antennas is calculated respectively.

For example, if the antenna switching capabilities of the terminal indicate 1T1R_2T2R and 1T1R_2T2R_4T4R and the pre-configured or specified receiving antenna numbers include receiving antenna number 1 and receiving antenna number 2, a set of configuration information of antenna switching is calculated according to the receiving antenna numbers 1 and 2.

For another example, if the antenna switching capabilities of the terminal indicate 1T1R_2T2R and 1T1R_2T2R_4T4R, a predetermined configuration is a measurement rollback mode, and the current configuration of the terminal is 4T4R, a set of configuration information of antenna switching is calculated according to the receiving antenna numbers 2 and 4.

(5) In another embodiment, for a number of receiving antennas corresponding to antenna switching capabilities supported by the terminal corresponding to a predefined switching strategy, the configuration information of antenna switching is calculated.

For example, if the predefined switching strategy is switching to antenna configuration 4T4R according to the antenna switching capability 1T1R_2T2R_4T4R supported by the terminal, the configuration information of antenna switching is calculated according to the receiving antenna number 4.

In some embodiments, when the network device supports a plurality of TRPs, the CSI measurement report may include the configuration information of antenna switching corresponding to one or a plurality of TRPs participating in the joint transmission and/or the configuration information of antenna switching obtained from the joint CSI measurement.

In this embodiment, according to a predetermined reporting mode, the terminal determines how to generate a CSI measurement report. According to the predetermined reporting mode, the CSI measurement report may include the configuration information of antenna switching corresponding to one or a plurality of TRPs participating in the joint transmission and/or the configuration information of antenna switching calculated from the joint CSI measurement. The predetermined reporting mode may instruct the terminal to report the CSI measurement report as follows.

(1) The terminal can report the configuration information of antenna switching corresponding to one or a plurality of TRPs participating in the joint transmission.

For example, after respectively performing CSI measurement for TRP1 and TRP2 participating in the joint transmission to calculate the configuration information of antenna switching corresponding to TRP1 and the configuration information of antenna switching corresponding to TRP2, the terminal may select one or a plurality of pieces from all the calculated configuration information of antenna switching to include in the CSI measurement report and report the CSI measurement report to the network device.

In some embodiments, the terminal may select part of the configuration information of antenna switching to include in the CSI measurement report and report the CSI measurement report to the network device, for example, report the configuration information of antenna switching corresponding to TRP1 to the network device.

In some embodiments, the terminal may select all the configuration information of antenna switching to include in the CSI measurement report and report the CSI measurement report to the network device, for example, report the configuration information of antenna switching corresponding to TRP1 and the configuration information of antenna switching corresponding to TRP2 to the network device.

(2) The terminal can report the configuration information of antenna switching calculated from joint CSI measurement for a plurality of TRPs participating in the joint transmission.

For example, after performing joint CSI measurement for TRP1 and TRP2 participating in the joint transmission to calculate the configuration information of antenna switching, the terminal can include the calculated configuration information of antenna switching in the CSI measurement report and report the CSI measurement report to the network device.

(3) The terminal can report the configuration information of antenna switching corresponding to one or a plurality of TRPs participating in the joint transmission and the configuration information of antenna switching calculated from the joint CSI measurement for a plurality of TRPs participating in the joint transmission.

For example, the terminal can include in the CSI measurement report the configuration information of antenna switching corresponding to TRP1, the configuration information of antenna switching corresponding to TRP2, and the configuration information of antenna switching calculated from the joint CSI measurement for TRP1 and TRP2 participating in joint transmission and report the CSI measurement report to the network device.

For another example, the terminal can include in the CSI measurement report the configuration information of antenna switching corresponding to TRP1 and the configuration information of antenna switching calculated from joint CSI measurement for TRP1 and TRP2 participating in the joint transmission and report the CSI measurement report to the network device.

Returning to FIG. 5, in S503, changing the antenna switching configuration of the terminal based on the CSI measurement report.

In this embodiment, after receiving the CSI measurement report, the network device may change the antenna switching configuration of the terminal based on the configuration information of antenna switching included in the CSI measurement report.

In the embodiment of the present disclosure, when switching of the antenna switching configuration is required, the network device sends a CSI measurement report request to the terminal to obtain a CSI measurement report including the configuration information of antenna switching from the terminal and switches the antenna switching configuration based on the CSI measurement report. Therefore, in the method for switching an antenna switching configuration according to the embodiment of the present disclosure, the antenna configuration supported by the terminal side is taken into consideration, so as to adapt to the terminal and service requirements faster and more flexibly to support the switching of the antenna switching configuration.

In some embodiments, the CSI measurement report further includes at least one of: an expected number of receiving antennas; an expected number of transmitting antennas; or an antenna switching configuration expected to switch to. The expected number of receiving antennas indicates the number of receiving antennas that the terminal expects to use, the expected number of transmitting antennas indicates the number of transmitting antennas that the terminal expects to use, and the antenna switching configuration expected to switch to indicates the antenna switching configuration that the terminal expects to use. The expected number of receiving antennas, the number of transmitting antennas or the antenna switching configuration expected to switch to is usually the number of receiving antennas, the number of transmitting antennas or the antenna switching configuration that results in better communication quality.

In this embodiment, the terminal can obtain the expected number m′ of receiving antennas according to the calculated CQI, and can obtain the expected number n′ of transmitting antennas according to RI calculation and/or transmission requirements, and can further determine the antenna switching configuration n′Tm′R expected to switch to, (that is, n′ transmitting antennas and m′ receiving antennas). The terminal may include in the CSI measurement report at least one of the expected number m′ of receiving antennas, the expected number n′ of transmitting antennas, or the antenna switching configuration n′Tm′R expected to switch to and report the above to the network device, so that the network device can switch the antenna switching configuration according to at least one of the expected number m′ of receiving antennas, the expected number n′ of transmitting antennas, or the antenna switching configuration n′Tm′R expected to switch to, included in the CSI measurement report, and the CQI.

In the embodiment of the present disclosure, at least one of the expected number m′ of receiving antennas, the expected number n′ of transmitting antennas, or the antenna switching configuration n′Tm′R expected to switch to and the CQI are simultaneously reported to the network device, so that the network device can fully consider the expected number of receiving antennas, the expected number of transmitting antennas and the antenna switching configuration expected to switch to on the terminal side when switching the antenna switching configuration.

FIG. 6 shows a schematic flowchart of a method for switching an antenna switching configuration according to an embodiment of the present disclosure. In this embodiment, the method is performed by a network device. As shown in FIG. 6, the method for switching an antenna switching configuration includes the following steps S601-S604.

In S601, sending to a terminal a CSI measurement report request related to switching of the antenna switching configuration, where the CSI measurement report request is configured to indicate a measurement resource of CSI measurement configuration.

In this embodiment, when switching of the antenna switching configuration is required, the network device can send a CSI measurement report request in response to the switching requirement of the antenna switching configuration, that is, the CSI measurement report request is sent for the switching of antenna switching configuration, so as to obtain relevant information from the terminal for performing the switching of antenna switching configuration.

The CSI measurement report request indicates a measurement resource configured for the CSI measurement and at least including channel measurement resources. In some embodiments, the CSI measurement report request may further include an interference measurement resource.

In S602, when the network device supports a plurality of TRPs, sending signaling to the terminal to configure a reporting mode for the terminal to report the configuration information of antenna switching. The reporting mode includes: including in the CSI measurement report all the configuration information of antenna switching calculated from the CSI transmission and/or the configuration information of antenna switching calculated from the joint CSI measurement and reporting the CSI measurement report.

In a communication system, there are network devices supporting a single TRP and/or network devices supporting a plurality of TRPs.

In some embodiments, when the network device supports a plurality of TRPs, the CSI measurement report can be obtained according to the configuration information of antenna switching in the following: configuration information of antenna switching corresponding to the TRPs participating in joint transmission, calculated by respectively performing CSI measurement based on channel measurement resources corresponding to the TRPs participating in the joint transmission; and/or the configuration information of antenna switching calculated by performing joint CSI measurement based on the channel measurement resources corresponding to the a plurality of TRPs participating in the joint transmission. The TRPs participating in the joint transmission are determined by a predefined multi-TRP transmission hypothesis or a multi-TRP transmission mode configured by the network device through signaling.

When the network device supports a plurality of TRPs, not all the plurality of TRPs participate in the joint transmission. The plurality of TRPs participating in the joint transmission can be determined according to the multi-TRP transmission hypothesis or according to the multi-TRP transmission mode configured by the network device through signaling.

In some embodiments, for example, there are a plurality of TRPs: TRP1, TRP2, TRP3 and TRP4, and the multi-TRP transmission mode configured by the network device through signaling is implemented in combination with TRP1, TRP2, and TRP4, the plurality of TRPs participating in the joint transmission can be determined as TRP1, TRP2 and TRP4.

In some embodiments, the multi-TRP transmission hypothesis may include one of: a multi-TRP transmission mode of a most recently scheduled downlink channel; or a multi-TRP transmission mode of a predefined downlink channel.

For example, there are a plurality of TRPs: TRP1, TRP2, TRP3, and TRP4. In some embodiments, a plurality of TRPs participating in the joint transmission can be determined according to the multi-TRP transmission mode of the most recently scheduled downlink channel. For example, if the multi-TRP transmission mode of the most recently scheduled downlink channel is implemented in combination with TRP1 and TRP2, the plurality of TRPs participating in the joint transmission can be determined as TRP1 and TRP2. If the multi-TRP transmission mode of the most recently scheduled downlink channel is implemented in combination with TRP1 and TRP3, the plurality of TRPs participating in the joint transmission can be determined as TRP1 and TRP3. In some other embodiments, a plurality of TRPs participating in the joint transmission can be determined according to the multi-TRP transmission mode of a predefined downlink channel. For example, if the multi-TRP transmission mode of the predefined downlink channel is implemented in combination with TRP1 and TRP2, the plurality of TRPs participating in the joint transmission can be determined as TRP1 and TRP2. If the multi-TRP transmission mode of the predefined downlink channel is implemented in combination with TRP2 and TRP3, the plurality of TRPs participating in the joint transmission can be determined as TRP2 and TRP3.

In some embodiments, the above-mentioned downlink channel may be a PDSCH, a PDCCH or other downlink channels.

After the a plurality of TRPs participating in the joint transmission are determined, CSI measurement can be performed respectively based on channel measurement resources corresponding to the TRPs participating in the joint transmission to calculate the configuration information of antenna switching corresponding to the TRPs participating in joint transmission; and/or joint CSI measurement is performed based on the channel measurement resources corresponding to the a plurality of TRPs participating in the joint transmission to calculate the configuration information of antenna switching.

For example, the CSI measurement can be performed as follows.

In the first way: for TRPs participating in the joint transmission, based on the channel measurement resources corresponding to the TRPs, CSI measurement is performed respectively to calculate the configuration information of antenna switching.

For example, if TRP1 and TRP2 are determined to participate in the joint transmission, CSI measurement is performed respectively based on the channel measurement resource corresponding to TRP1 and based on the channel measurement resource corresponding to TRP2 to calculate the configuration information of antenna switching.

For example, for TRP1, one or a plurality of NZP CSI-RSs corresponding to TRP1 are used as channel measurement resources to perform CSI measurement to calculate the configuration information of antenna switching corresponding to TRP1. The one or a plurality of NZP CSI-RSs at least include latest received NZP CSI-RSs, and in one example, further include previously received NZP CSI-RSs.

For TRP2, one or a plurality of NZP CSI-RSs corresponding to TRP2 are used as channel measurement resources to perform CSI measurement to calculate the configuration information of antenna switching corresponding to TRP2.

In the second way: based on the channel measurement resources corresponding to the plurality of TRPs participating in the joint transmission, the joint CSI measurement is performed to calculate the configuration information of antenna switching.

For example, if TRP1 and TRP2 are determined to participate in the joint transmission, the joint CSI measurement is performed based on channel measurement resources corresponding to TRP1 and TRP2 to calculate the configuration information of antenna switching.

In the third way: CSI measurement and calculation are performed by combining the first way and the second way.

In this way, CSI measurement is performed respectively based on the channel measurement resources corresponding to the TRPs, and joint CSI measurement is performed based on the channel measurement resources corresponding to a plurality of TRPs participating in the joint transmission, so as to calculate the configuration information of antenna switching.

For example, if TRP1 and TRP2 are determined to participate in the joint transmission, CSI measurement is respectively performed based on the channel measurement resource corresponding to TRP1 and based on the channel measurement resource corresponding to TRP2 and joint CSI measurement is performed based on the channel measurement resources corresponding to TRP1 and TRP2, so as to calculate the configuration information of antenna switching.

As mentioned above, when the network device supports a plurality of TRPs, the terminal can perform CSI measurement in many ways to calculate the configuration information of antenna switching, and accordingly there are many ways to report the CSI measurement report generated according to the calculated configuration information of antenna switching. In this embodiment, the network device can instruct the terminal how to generate and report the CSI measurement report through signaling configuration.

For example, the signaling configuration of the network device may instruct the terminal to report the CSI measurement report as follows.

(1) The terminal can report the configuration information of antenna switching corresponding to each TRP participating in the joint transmission.

For example, after performing CSI measurement for TRP1 and TRP2 participating in the joint transmission to calculate the configuration information of antenna switching corresponding to TRP1 and the configuration information of antenna switching corresponding to TRP2, the terminal can include all the calculated configuration information of antenna switching in the CSI measurement report and report the CSI measurement report to the network device. That is, the configuration information of antenna switching corresponding to TRP1 and the configuration information of antenna switching corresponding to TRP2 are reported to the network device.

(2) The terminal can report the configuration information of antenna switching calculated from joint CSI measurement for a plurality of TRPs participating in the joint transmission.

For example, after performing joint CSI measurement for TRP 1 and TRP2 participating in the joint transmission to calculate the configuration information of antenna switching, the terminal can include the calculated configuration information of antenna switching in the CSI measurement report and report the CSI measurement report to the network device.

(3) The terminal can report the configuration information of antenna switching corresponding to each TRP participating in the joint transmission and the configuration information of antenna switching calculated from the joint CSI measurement for a plurality of TRPs participating in the joint transmission.

For example, the terminal can include in the CSI measurement report the configuration information of antenna switching corresponding to TRP1, the configuration information of antenna switching corresponding to TRP2, and the configuration information of antenna switching calculated from the joint CSI measurement for TRP1 and TRP2 participating in joint transmission and report the CSI measurement report to the network device.

It should be noted that the above steps S601 and S602 can be executed in any order, for example, step S602 can be executed first, and then S601 can be executed; or steps S601 and S602 can be executed simultaneously.

Returning to FIG. 6, in S603, receiving a CSI measurement report fed back by the terminal in response to the CSI measurement report request, where the CSI measurement report includes the configuration information of antenna switching.

In this embodiment, the network device receives from the terminal the CSI measurement report sent by the terminal. After receiving the CSI measurement report request, the terminal may perform CSI measurement in response to the CSI measurement report request to obtain a CSI measurement report including the configuration information of antenna switching and feed the CSI measurement report back to the network device.

In some embodiments, the configuration information of antenna switching includes at least one CQI or the configuration information of antenna switching includes at least one set of CQI and RI.

The CSI measurement report obtained by the terminal may include at least one CQI, or include at least one set of CQI/RI. Specifically, as described below, the network device may switch the antenna switching configuration according to at least one CQI or at least one set of CQI/RI included in the CSI measurement report.

In S604, changing the antenna switching configuration of the terminal based on the CSI measurement report.

In this embodiment, after receiving the CSI measurement report, the network device may change the antenna switching configuration of the terminal based on the configuration information of antenna switching included in the CSI measurement report.

In the embodiment of the present disclosure, when switching of the antenna switching configuration is required, the network device sends a CSI measurement report request to the terminal to obtain a CSI measurement report including the configuration information of antenna switching from the terminal and switches the antenna switching configuration based on the CSI measurement report. Therefore, in the method for switching an antenna switching configuration according to the embodiment of the present disclosure, the antenna configuration supported by the terminal side is taken into consideration, so as to adapt to the terminal and service requirements faster and more flexibly to support the switching of the antenna switching configuration.

In some embodiments, the CSI measurement report further includes at least one of: an expected number of receiving antennas; an expected number of transmitting antennas; or an antenna switching configuration expected to switch to. The expected number of receiving antennas indicates the number of receiving antennas that the terminal expects to use, the expected number of transmitting antennas indicates the number of transmitting antennas that the terminal expects to use, and the antenna switching configuration expected to switch to indicates the antenna switching configuration that the terminal expects to use. The expected number of receiving antennas, the number of transmitting antennas or the antenna switching configuration expected to switch to is usually the number of receiving antennas, the number of transmitting antennas or the antenna switching configuration that results in better communication quality.

In this embodiment, the terminal can obtain the expected number m′ of receiving antennas according to the calculated CQI, and can obtain the expected number n′ of transmitting antennas according to RI calculation and/or transmission requirements, and can further determine the antenna switching configuration n′Tm′R expected to switch to, (that is, n′ transmitting antennas and m′ receiving antennas). The terminal may include in the CSI measurement report at least one of the expected number m′ of receiving antennas, the expected number n′ of transmitting antennas, or the antenna switching configuration n′Tm′R expected to switch to and report the above to the network device, so that the network device can switch the antenna switching configuration according to at least one of the expected number m′ of receiving antennas, the expected number n′ of transmitting antennas, or the antenna switching configuration n′Tm′R expected to switch to, included in the CSI measurement report, and the CQI.

In the embodiment of the present disclosure, at least one of the expected number m′ of receiving antennas, the expected number n′ of transmitting antennas, or the antenna switching configuration n′Tm′R expected to switch to and the CQI are simultaneously reported to the network device, so that the network device can fully consider the expected number of receiving antennas, the expected number of transmitting antennas and the antenna switching configuration expected to switch to on the terminal side when switching the antenna switching configuration.

Corresponding to the methods for switching an antenna switching configurations provided in the above embodiments, the present disclosure further provides an apparatus for switching an antenna switching configuration. Since the device for switching an antenna switching configuration provided by the embodiment of the present disclosure corresponds to the methods for switching an antenna switching configuration provided in the foregoing embodiments, the implementations of the method for switching an antenna switching configuration are also applicable to the device for switching an antenna switching configuration provided in this embodiment, and will not be described in details in this embodiment.

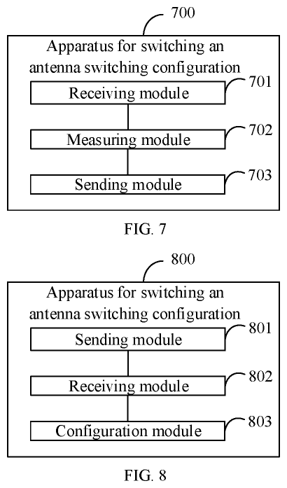

FIG. 7 is a schematic structural diagram of an apparatus for switching an antenna switching configuration according to an embodiment of the present disclosure. The device is applied to a terminal.

As shown in FIG. 7, the apparatus 700 for switching an antenna switching configuration includes a receiving module 701, a measuring module 702, and a sending module 703.

The receiving module 701 is configured to receive a CSI measurement report request related to switching of the antenna switching configuration, where the CSI measurement report request is configured to indicate a measurement resource of CSI measurement configuration.

The measuring module 702 is configured to perform CSI measurement to obtain a CSI measurement report, where the CSI measurement report includes configuration information of antenna switching.

The sending module 703 is configured to send the antenna switching configuration of the terminal based on the CSI measurement report.

In the embodiment of the present disclosure, after receiving the CSI measurement report request, the terminal reports the CSI measurement report including the configuration information of antenna switching to the network device, so that the network device can switch the antenna switching configuration based on the CSI measurement report. Therefore, in the method for switching an antenna switching configuration according to the embodiment of the present disclosure, the antenna configuration supported by the terminal side is taken into consideration, so as to adapt to the terminal and service requirements faster and more flexibly to support the switching of the antenna switching configuration.

In some embodiments, the configuration information of antenna switching includes at least one CQI corresponding to the antenna switching configuration or the configuration information of antenna switching includes at least one set of CQI and RI.

In some embodiments, the CSI measurement report further includes at least one of: an expected number of receiving antennas; an expected number of transmitting antennas; or an antenna switching configuration expected to switch to.

In some embodiments, the measuring module 702 is configured to, for a network device supporting a single TRP, perform CSI measurement based on a channel measurement resource corresponding to the TRP to calculate the configuration information of antenna switching to obtain a CSI measurement report.

In some embodiments, the measuring module 702 is configured to, for a network device supporting a plurality of TRPs, determine a plurality of TRPs participating in joint transmission based on a predefined multi-TRP transmission hypothesis or a multi-TRP transmission mode configured by the network device through signaling; and respectively perform CSI measurement based on channel measurement resources corresponding to the TRPs participating in the joint transmission to calculate the configuration information of antenna switching respectively corresponding to the TRPs participating in the joint transmission and/or perform joint CSI measurement based on the channel measurement resources corresponding to the a plurality of TRPs participating in the joint transmission to calculate the configuration information of antenna switching, so as to obtain the CSI measurement report.

In some embodiments, the measuring module 702 is configured to calculate the configuration information of antenna switching according to a calculation rule and according to a plurality of numbers of receiving antennas corresponding to antenna switching capabilities supported by the terminal.

In some embodiments, the calculation rule includes one of the following: for a group of different numbers of receiving antennas corresponding to different antenna switching capabilities supported by the terminal, respectively calculating configuration information of antenna switching corresponding to different numbers of receiving antennas; for one or a plurality of numbers of receiving antennas corresponding to the antenna switching capability configuration not greater than the configuration on the BWP of the terminal, respectively calculating the configuration information of antenna switching corresponding to different numbers of receiving antennas; for one or a plurality of numbers of receiving antennas corresponding to the antenna switching capabilities supported by the terminal and not greater than a preset number, respectively calculating the configuration information of antenna switching corresponding to different numbers of receiving antennas; for pre-configured or specified one or a plurality of numbers of receiving antennas corresponding to antenna switching capabilities supported by the terminal, respectively calculating the configuration information of antenna switching corresponding to different numbers of receiving antennas; or for a number of receiving antennas corresponding to antenna switching capabilities supported by the terminal corresponding to a predefined switching strategy, calculating the configuration information of antenna switching.

In some embodiments, the measuring module 702 is configured to: receive signaling configuration about a reporting mode, and according to the signaling configuration, include in the CSI measurement report the configuration information of antenna switching corresponding to each TRP participating in the joint transmission and/or the configuration information of antenna switching obtained from the joint CSI measurement; or according to a predetermined reporting mode of the terminal, include in the CSI measurement report the configuration information of antenna switching corresponding to one or a plurality of TRPs participating in the joint transmission and/or the configuration information of antenna switching obtained from the joint CSI measurement.

In some embodiments, the predefined multi-TRP transmission hypothesis includes one of: the most recently scheduled multi-TRP transmission mode of a downlink channel; or the predefined multi-TRP transmission mode of a downlink channel.

In some embodiments, the downlink channel is a PDSCH or a PDCCH.

FIG. 8 is a schematic structural diagram of an apparatus for switching an antenna switching configuration according to an embodiment of the present disclosure. The apparatus is applied to a network device.

As shown in FIG. 8, the apparatus 800 for switching an antenna switching configuration includes a sending module 801, a receiving module 802, and a configuration module 803.

The sending module 801 is configured to send to the terminal a CSI measurement report request related to switching of the antenna switching configuration, where the CSI measurement report request is configured to indicate a measurement resource of CSI measurement configuration.

The receiving module 802 is configured to receive a CSI measurement report sent by the terminal, where the CSI measurement report includes configuration information of antenna switching.

The configuration module 803 is configured to change the antenna switching configuration of the terminal based on the CSI measurement report.

In the embodiment of the present disclosure, when switching of the antenna switching configuration is required, the network device sends a CSI measurement report request to the terminal to obtain a CSI measurement report including the configuration information of antenna switching from the terminal and switches the antenna switching configuration based on the CSI measurement report. Therefore, in the method for switching an antenna switching configuration according to the embodiment of the present disclosure, the antenna configuration supported by the terminal side is taken into consideration, so as to adapt to the terminal and service requirements faster and more flexibly to support the switching of the antenna switching configuration.

In some embodiments, the configuration information of antenna switching includes at least one CQI corresponding to the antenna switching configuration or the configuration information of antenna switching includes at least one set of CQI and RI (CQI/RI).

In some embodiments, the CSI measurement report further includes at least one of: an expected number of receiving antennas; an expected number of transmitting antennas; or an antenna switching configuration expected to switch to.

In some embodiments, when the network device supports a single TRP, the CSI measurement report is obtained according to the configuration information of antenna switching calculated by performing CSI measurement based on a channel measurement resource corresponding to the TRP.

In some embodiments, when the network device supports a plurality of TRPs, the CSI measurement report can be obtained according to the configuration information of antenna switching in the following: configuration information of antenna switching corresponding to the TRPs participating in joint transmission, calculated by respectively performing CSI measurement based on channel measurement resources corresponding to the TRPs participating in the joint transmission; and/or the configuration information of antenna switching calculated by performing joint CSI measurement based on the channel measurement resources corresponding to the a plurality of TRPs participating in the joint transmission. The plurality of TRPs participating in the joint transmission are determined by a predefined multi-TRP transmission hypothesis or a multi-TRP transmission mode configured by the network device through signaling.

In some embodiments, the configuration information of antenna switching is calculated according to a calculation rule and a plurality of numbers of receiving antennas corresponding to antenna switching capabilities supported by the terminal.

In some embodiments, the calculation rule includes one of the following: for a group of different numbers of receiving antennas corresponding to different antenna switching capabilities supported by the terminal, respectively calculating configuration information of antenna switching corresponding to different numbers of receiving antennas. For one or a plurality of numbers of receiving antennas corresponding to the antenna switching capability configuration not greater than the configuration on the BWP of the terminal, respectively calculating the configuration information of antenna switching corresponding to different numbers of receiving antennas. For one or a plurality of numbers of receiving antennas corresponding to the antenna switching capabilities supported by the terminal and not greater than a preset number, respectively calculating the configuration information of antenna switching corresponding to different numbers of receiving antennas. For pre-configured or specified one or a plurality of numbers of receiving antennas corresponding to antenna switching capabilities supported by the terminal, respectively calculating the configuration information of antenna switching corresponding to different numbers of receiving antennas. Or for a number of receiving antennas corresponding to antenna switching capabilities supported by the terminal corresponding to a predefined switching strategy, calculating the configuration information of antenna switching.

In some embodiments, the CSI measurement report includes the configuration information of antenna switching corresponding to one or a plurality of TRPs participating in the joint transmission and/or the configuration information of antenna switching calculated from the joint CSI measurement.

In some embodiments, the sending module 801 is configured to send signaling to the terminal to configure a reporting mode for the terminal to report the configuration information of antenna switching, where the reporting mode includes: including in the CSI measurement report the configuration information of antenna switching corresponding to each TRP participating in the joint transmission and/or the configuration information of antenna switching obtained from the joint CSI measurement and report the CSI measurement report.

In some embodiments, the predefined multi-TRP transmission hypothesis includes one of: the most recently scheduled multi-TRP transmission mode of a downlink channel; or the predefined multi-TRP transmission mode of a downlink channel.

In some embodiments, the downlink channel is a PDSCH or a PDCCH.

According to an embodiment of the present invention, the present disclosure further provides a communication device and a computer-readable storage medium.

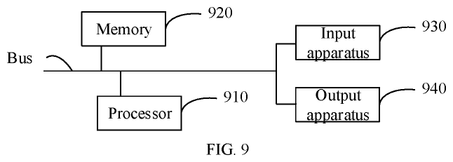

As shown in FIG. 9, it is a block diagram of a communication device according to an embodiment of the present disclosure. The communication device is intended to represent digital computers in various forms, such as a laptop computer, a desktop computer, a workstation, a personal digital assistant, a server, a blade server, a mainframe computer, and other suitable computers. The communication device may further represent mobile devices in various forms, such as a personal digital assistant, a cellular phone, a smart phone, a wearable device, and other similar computing devices. The components shown herein, connections and relationships of the components, and functions of the components are examples, and are not intended to limit the implementation of the present disclosure described and/or required herein.

As shown in FIG. 9, the communication device includes: one or a plurality of processors 910, a memory 920, and interfaces configured to connect the components, including high-speed interfaces and low-speed interfaces. The components are connected with each other by different buses, and may be installed on a common mainboard or may be installed in other manners as needed. The processor may process instructions executed within the communication device, including instructions stored in the memory or on the memory to display graphical information of a GUI on an external input/output apparatus (such as a display apparatus coupled to an interface). In other implementations, a plurality of processors and/or a plurality of buses may be used together with a plurality of memories and a plurality of memories as needed. Similarly, a plurality of communication devices may be connected, and each device provides part of necessary operations (such as serving as a server array, a set of blade servers, or a multi-processor system). One processor 910 is taken as an example in FIG. 9.

The memory 920 is a non-transitory computer-readable storage medium provided by the present disclosure. Instructions that may be executed by at least one processor are stored in the memory, so that the at least one processor performs the method for switching an antenna switching configuration provided by the present disclosure. Computer instructions are stored in the non-transitory computer-readable storage medium of the present disclosure, and configured to enable a computer to execute the method for switching an antenna switching configuration provided by the present disclosure.

As a non-transitory computer-readable storage medium, the memory 920 may be configured to store non-transitory software programs, non-transitory computer-executable programs, and modules, such as program instructions/modules corresponding to the method for switching an antenna switching configuration in the embodiments of the present disclosure. By executing the non-transitory software programs, instructions, and modules stored in the memory 920, the processor 910 executes various functional applications and data processing of a server, that is, realizes the method for switching an antenna switching configuration in the above method embodiments.

The memory 920 may include a program storage area and a data storage area, where application programs required by an operating system and at least one function may be stored in the program storage area, and data created according to usage of a positioning communication device, and the like, may be stored in the data storage area. In addition, the memory 920 may include a high-speed random access memory, and may further include a non-transitory memory, such as at least one magnetic disk storage device, a flash memory device, or other non-transitory solid-state storage devices. Alternatively, the memory 920 may include memories which are remotely arranged relative to the processor 910, and the remote memories may be connected to the positioning communication device through a network. Examples of the above network include, but are not limited to, the Internet, an enterprise Intranet, a local area network, a mobile communication network, and combinations of the above.

The communication device may further include: an input apparatus 930 and output apparatus 940. The processor 910, the memory 920, the input apparatus 930 and the output apparatus 940 may be connected with each other by buses or in other manners. In FIG. 9, bus connection is taken as an example.

The input apparatus 930 may receive input digital or character information, and generate key signal input related to user setting and function control of the positioning communication device, and may be, such as, a touch screen, a keypad, a mouse, a trackpad, a touchpad, an indicator rod, one or a plurality of mouse buttons, a trackball, a joystick, and the like. The output apparatus 940 may include a display apparatus, an auxiliary illumination apparatus (such as an LED), a tactile feedback apparatus (such as a vibration motor), and the like. The display apparatus may include, but is not limited to, a liquid crystal display (LCD), a light-emitting diode (LED) display, and a plasma display. In some implementations, the display apparatus may be a touch screen.

The implementations of systems and technologies described herein may be realized in a digital electronic circuit system, an integrated circuit system, a dedicated ASIC (application-specific integrated circuit), computer hardware, firmware, software, and/or combinations of the above. The implementations may include: being implemented in one or a plurality of computer programs, where the one or a plurality of computer programs may be executed and/or interpreted in a programmable system including at least one programmable processor, and the programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

The computing programs (also known as programs, software, software applications, or codes) include machine instructions of the programmable processor, and may be implemented by an advanced process and/or an object-oriented programming language, and/or an assembly/machine language. As used herein, the terms ‘machine-readable medium’ and ‘computer-readable medium’ refer to any computer program products, devices, and/or apparatuses (such as magnetic disks, optical disks, memories, and programmable logic apparatuses (PLDs)) configured to provide the machine instructions and/or data to the programmable processor, and include machine-readable mediums that receive the machine instructions which are taken as machine-readable signals. The term ‘machine-readable signal’ refers to any signal configured to provide the machine instructions and/or data to the programmable processor.

In order to provide interaction with a user, the systems and technologies described herein may be implemented in a computer, where the computer is provided with: a display apparatus (such as a CRT (cathode ray tube) or an LCD (liquid crystal display) monitor) configured to display information to the user; and a keyboard and a pointing apparatus (such as a mouse or a trackball), and the user may provide input to the computer through the keyboard and the pointing apparatus. Other types of apparatuses may also be configured to provide interaction with the user, for example, feedback provided to the user may be sensory feedback in any form (such as visual feedback, auditory feedback, or tactile feedback), and the input of the user may be received in any form (including vocal input, speech input, or tactile input).

The systems and technologies described herein may be implemented in a computing system (for example, as a data server) including a background component, or a computing system (for example, an application server) including a middleware component, or a computing system (for example, a user computer with a graphical user interface or a web browser through which the user may interact with the implementations of the systems and technologies described herein) including a front-end component, or a computing system including any combination of the background component, the middleware component, or the front-end component. The components of the system may be connected with each other through digital data communication (for example, a communication network) in any form or medium. Examples of the communication network include: a local area network (LAN), a wide area network (WAN), and the Internet.

The computer system may include a client and a server. The client and the server are generally far away from each other and usually interact through the communications network. A relationship between the client and the server is generated by computer programs executed in respective computers and having a client-server relationship with each other.

It needs to be understood that, the steps may be reordered, added, or deleted by using the flows in various forms, which are shown above. For example, the steps disclosed in the present disclosure may be performed in parallel or sequentially, or in a different order, provided that the desired result of the technical solutions disclosed in the present disclosure can be achieved, which is not limited herein.

The above specific implementations do not constitute a limitation on the scope of the present disclosure. Those skilled in the art need to understand that, various modifications, combinations, sub-combinations, and substitutions may be made according to design requirements and other factors. Any modifications, equivalent substitutions, and improvements made within the spirit and principles of the present disclosure should be included within the scope of the present disclosure.

1. A method for switching an antenna switching configuration, performed by a terminal and comprising:
receiving a channel state information (CSI) measurement report request related to switching of the antenna switching configuration, wherein the CSI measurement report request is configured to indicate a measurement resource of CSI measurement configuration;
performing CSI measurement to obtain a CSI measurement report, wherein the CSI measurement report comprises configuration information of antenna switching; and
reporting the CSI measurement report to a network device.

2. The method according to claim 1, wherein the configuration information of antenna switching comprises:
at least one channel quality indicator (CQI) corresponding to the antenna switching configuration; or
at least one set of CQI and rank indicator (RI) corresponding to the antenna switching configuration.

3. The method according to claim 1, wherein the CSI measurement report further comprises at least one of:
an expected number of receiving antennas;
an expected number of transmitting antennas; or
an antenna switching configuration expected to switch to.

4. The method according to claim 1, wherein performing CSI measurement to obtain a CSI measurement report comprises at least one of:
for a network device supporting a single transport receive point (TRP), performing CSI measurement based on a channel measurement resource corresponding to the TRP to calculate the configuration information of antenna switching to obtain the CSI measurement report; or
for a network device supporting a plurality of TRPs,
determining a plurality of TRPs participating in joint transmission based on a predefined multi-TRP transmission hypothesis or a multi-TRP transmission mode configured by the network device through signaling; and
respectively performing at least one of a CSI measurement based on channel measurement resources corresponding to the TRPs participating in the joint transmission to calculate the configuration information of antenna switching respectively corresponding to the TRPs participating in the joint transmission or a joint CSI measurement based on the channel measurement resources corresponding to the a plurality of TRPs participating in the joint transmission to calculate the configuration information of antenna switching to obtain the CSI measurement report.

5. (canceled)

6. The method according to claim 4, wherein calculating the configuration information of antenna switching comprises:
calculating the configuration information of antenna switching according to a calculation rule and a plurality of numbers of receiving antennas corresponding to antenna switching capabilities supported by the terminal.

7. The method according to claim 6, wherein the calculation rule comprises one of:
for a group of different numbers of receiving antennas corresponding to different antenna switching capabilities supported by the terminal, respectively calculating the configuration information of antenna switching corresponding to different numbers of receiving antennas;
for one or a plurality of numbers of receiving antennas corresponding to the antenna switching capability configuration not greater than the configuration on the current BWP of the terminal, respectively calculating the configuration information of antenna switching corresponding to different numbers of receiving antennas;
for one or a plurality of numbers of receiving antennas corresponding to the antenna switching capabilities supported by the terminal and not greater than a preset number, respectively calculating the configuration information of antenna switching corresponding to different numbers of receiving antennas;
for pre-configured or specified one or a plurality of numbers of receiving antennas corresponding to antenna switching capabilities supported by the terminal, respectively calculating the configuration information of antenna switching corresponding to different numbers of receiving antennas; or
for a number of receiving antennas corresponding to antenna switching capabilities supported by the terminal corresponding to a predefined switching strategy, calculating the configuration information of antenna switching.

8. The method according to claim 4, wherein obtaining the CSI measurement report comprises:
receiving signaling configuration about a reporting mode, and according to the signaling configuration, comprising in the CSI measurement report at least one of the configuration information of antenna switching corresponding to each TRP participating in the joint transmission or the configuration information of antenna switching obtained from the joint CSI measurement; or
according to a predetermined reporting mode of the terminal, comprising in the CSI measurement report at least one of the configuration information of antenna switching corresponding to one or a plurality of TRPs participating in the joint transmission or the configuration information of antenna switching obtained from the joint CSI measurement.

9. The method according to claim 4, wherein the predefined multi-TRP transmission hypothesis comprises one of:
a multi-TRP transmission mode of a most recently scheduled downlink channel; or
a multi-TRP transmission mode of a predefined downlink channel.

10. (canceled)

11. A method for switching an antenna switching configuration, performed by a network device and comprising:
sending to a terminal a CSI measurement report request related to switching of the antenna switching configuration, wherein the CSI measurement report request is configured to indicate a measurement resource of CSI measurement configuration;
receiving a CSI measurement report sent by the terminal, wherein the CSI measurement report comprises configuration information of antenna switching; and
changing the antenna switching configuration of the terminal based on the CSI measurement report.

12. The method according to claim 11, wherein the configuration information of antenna switching comprises:
at least one channel quality indicator (CQI) corresponding to the antenna switching configuration; or
at least one set of CQI and rank indicator (RI) corresponding to the antenna switching configuration.

13. The method according to claim 11, wherein the CSI measurement report further comprises at least one of:
an expected number of receiving antennas for the terminal;
an expected number of transmitting antennas for the terminal; or
an antenna switching configuration expected by the terminal to switch to.

14. The method according to claim 11, wherein,
on a condition that the network device supports a single TRP, the CSI measurement report is obtained according to the configuration information of antenna switching calculated by performing CSI measurement based on a channel measurement resource corresponding to the TRP; and
on a condition that the network device supports a plurality of TRPs, the CSI measurement report is obtained according to the configuration information of antenna switching in at least one of:
configuration information of antenna switching respectively corresponding to TRPs participating in joint transmission, calculated by respectively performing CSI measurement based on channel measurement resources corresponding to the TRPs participating in the joint transmission; or
the configuration information of antenna switching calculated by performing joint CSI measurement based on the channel measurement resources corresponding to the plurality of TRPs participating in the joint transmission;
wherein the plurality of TRPs participating in the joint transmission are determined by a predefined multi-TRP transmission hypothesis or a multi-TRP transmission mode configured by the network device through signaling.

15. (canceled)

16. The method according to claim 14, wherein the configuration information of antenna switching is calculated according to a calculation rule and a plurality of numbers of receiving antennas corresponding to antenna switching capabilities supported by the terminal.

17. The method according to claim 16, wherein the calculation rule comprises one of:
for a group of different numbers of receiving antennas corresponding to different antenna switching capabilities supported by the terminal, respectively calculating the configuration information of antenna switching corresponding to different numbers of receiving antennas;
for one or a plurality of numbers of receiving antennas corresponding to the antenna switching capability configuration not greater than the configuration on the current BWP of the terminal, respectively calculating the configuration information of antenna switching corresponding to different numbers of receiving antennas;
for one or a plurality of numbers of receiving antennas corresponding to the antenna switching capabilities supported by the terminal and not greater than a preset number, respectively calculating the configuration information of antenna switching corresponding to different numbers of receiving antennas;
for pre-configured or specified one or a plurality of numbers of receiving antennas corresponding to antenna switching capabilities supported by the terminal, respectively calculating the configuration information of antenna switching corresponding to different numbers of receiving antennas; or
for a number of receiving antennas corresponding to antenna switching capabilities supported by the terminal corresponding to a predefined switching strategy, calculating the configuration information of antenna switching.

18. The method according to claim 14, wherein the CSI measurement report comprises at least one of configuration information of antenna switching corresponding to one or a plurality of TRPs participating in the joint transmission or configuration information of antenna switching obtained from the joint CSI measurement.

19. The method according to claim 18, further comprising:
sending signaling to the terminal to configure a reporting mode for the terminal to report the configuration information of antenna switching,
wherein the reporting mode comprises: comprising in the CSI measurement report at least one of the configuration information of antenna switching corresponding to each TRP participating in the joint transmission or the configuration information of antenna switching obtained from the joint CSI measurement and then reporting the CSI measurement report.

20-23. (canceled)

24. A communication device, comprising: a transceiver; a memory; and a processor connected to the transceiver and the memory respectively, which is configured to control radio signal transceiving of the transceiver by executing computer executable instructions on the memory, and;
receive a channel state information (CSI) measurement report request related to switching of the antenna switching configuration, wherein the CSI measurement report request is configured to indicate a measurement resource of CSI measurement configuration;
perform CSI measurement to obtain a CSI measurement report, wherein the CSI measurement report comprises configuration information of antenna switching; and
report the CSI measurement report to a network device.

25. A communication device, comprising: a transceiver; a memory; and a processor connected to the transceiver and the memory respectively, which is configured to control radio signal transceiving of the transceiver by executing computer executable instructions on the memory, and performs the method according to claim 11.

26. A non-transitory computer readable storage medium storing computer-executable instructions, wherein the computer-executable instructions, when being executed by a processor, performs the method according to claim 1.

27. A non-transitory computer readable storage medium storing computer-executable instructions, wherein the computer-executable instructions when being executed by a processor, performs the method according to claim 11.
